(19) United States
(12) Patent Application Publication
(10) Pub. No.: US 2009/0219278 A1
(43) Pub. Date: Sep. 3, 2009

(54) Electroluminescence display panel, electronic apparatus and driving method for electroluminescence display panel

(75) Inventors: Tetsuro Yamamoto, Kanagawa (JP); Katsuhide Uchino, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 12/320,862

(22) Filed: Feb. 6, 2009

(30) Foreign Application Priority Data
Feb. 28, 2008 (JP) 2008-048512

(51) Int. Cl. G09G 5/00; G09G 3/30

(52) U.S. Cl. 345/214; 345/76

(57) ABSTRACT

An EL display panel having a pixel structure ready for an active matrix driving method, includes: an input signal line driving section configured to output an intermediate potential for mobility correction, a threshold value correction potential and a signal potential corresponding to a gradation value in order for each horizontal scanning period; and a writing controlling driving section configured to have a control period for keeping an on state of a sampling transistor for controlling writing of the potentials within a period beginning with a timing midway of an application period of the intermediate potential and ending with another point of time midway of an application period of the signal potential.

### CROSS REFERENCES TO RELATED APPLICATIONS

The present invention contains subject matter related to Japanese Patent Application JP 2008-048512 filed in the Japan Patent Office on Feb. 28, 2008, the entire contents of which being incorporated herein by reference.

### BACKGROUND OF THE INVENTION

1. Field of the Invention

This invention relates to an EL (electroluminescence) display panel which is driven and controlled by an active matrix driving method and a driving technique for an EL display panel. More specifically, the present invention relates to an EL display panel, an electronic apparatus and a driving method for an EL display panel.

2. Description of the Related Art

FIG. 1 shows a circuit configuration popularly used in an organic EL panel of the active matrix driving type. Referring to FIG. 1, the organic EL panel 1 shown includes a pixel array section 3, and a signal writing control line driving section (WSCN) 5 and a horizontal selector (HSEL) 7 serving as driving circuits for the pixel array section 3. It is to be noted that, in the pixel array section 3, a pixel circuit 9 is disposed at each of intersecting points of signal lines DTL and writing control lines WSL.

Incidentally, an organic element is a current light emitting element. Therefore, for the organic EL panel, a driving method of controlling the gradation by control of the amount of current to flow through an organic EL element corresponding to each pixel is adopted.

FIG. 2 shows one of comparatively simple circuit configurations of the pixel circuit 9 of the type described. Referring to FIG. 2, the pixel circuit 9 includes thin film transistors T1 and T2 and a storage capacitor Cs. In the following description, the thin film transistor T1 is referred to as “sampling transistor T1” and the thin film transistor T2 is referred to as “driving transistor T2.”

The sampling transistor T1 is a thin film transistor of the N channel type for controlling writing of a signal potential Vsig corresponding to a gradation of a corresponding pixel into the storage capacitor Cs. Meanwhile, the driving transistor T2 is a thin film transistor of the P channel type for supplying driving current Ids to an organic EL element OLED based on a gate-source voltage Vgs of the driving transistor T2 which depends upon the signal potential Vsig stored in the storage capacitor Cs.

In the circuit shown in FIG. 2, the driving transistor T2 is connected at the source electrode thereof to a current supply line to which a power supply potential Vcc is fixedly applied and normally operates in a saturation region. In other words, the driving transistor T2 operates as a constant current source for supplying driving current of a magnitude corresponding to the signal potential Vsig to the organic EL element OLED. Thereupon, the driving current Ids is given by the following expression:

Ids=k·μ·(Vgs−Vth)²/2

where μ is the mobility of the majority carrier of the driving transistor T2, Vth is the threshold voltage of the driving transistor T2, and k is a coefficient given by (W/L)·Cox, where W is the channel width, L is the channel length, and Cox is the gate capacitance per unit area.

It is to be noted that, in the configuration of the pixel circuit described, the drain voltage of the driving transistor T2 varies together with the aged deterioration of the I-V characteristic of an organic EL element illustrated in FIG. 3.

However, since the gate-source voltage Vgs is kept fixed, the amount of current supplied to the organic EL element does not vary, and the luminance of emitted light can be kept fixed.

An organic EL display panel which adopts the active matrix driving method is disclosed, for example, in Japanese Patent Laid-Open Nos. 2003-255856, 2003-271095, 2004-133240, 2004-029791 and 2004-093682.

### SUMMARY OF THE INVENTION

Incidentally, depending upon the type of the thin film process, the circuit configuration shown in FIG. 2 may not possibly be adopted. Specifically, in an existing thin film transistor with a P-channel type may not be adapted. For example, an amorphous silicon process cannot be adopted. In such an instance, it is necessary to replace the driving transistor T2 with an N-channel type thin film transistor.

FIG. 4 shows an example of a configuration of a pixel circuit of the type just described. Referring to FIG. 4, in the circuit configuration shown, a driving transistor T12 is connected at the source electrode thereof to the anode electrode of an organic EL element OLED. However, the pixel circuit 11 has a problem in that the gate-source voltage Vgs varies in response to the aged deterioration of the I-V characteristic of the organic EL element. The variation of the gate-source voltage Vgs in turn varies the driving current amount and varies the luminance of the emitted light.

Further, the threshold value and the mobility of the driving transistor T12 which composes the pixel circuit 11 differ for each pixel. The difference in the threshold value and the mobility of the driving transistor T12 appears as a dispersion of the driving current value, and this makes the luminance of the emitted light vary for each pixel.

Accordingly, a pixel circuit for the organic EL panel 1 which adopts a circuit configuration for preventing a characteristic dispersion of a driving transistor formed from an N-channel thin film transistor and driving circuits for the pixel circuit are demanded. FIG. 5 shows an example of a driving circuit of the type just described. Here, the pixel circuit 21 is formed from N-channel thin film transistors T21 and T22 and a storage capacitor Cs.

The thin film transistor T21 (hereinafter referred to as “sampling transistor T21”) operates as a switch for controlling writing of the signal potential Vsig. Meanwhile, the thin film transistor T22 (hereinafter referred to as “driving transistor T22”) operates as a constant current source for supplying driving current when the organic EL element OLED operates to emit light.

For driving of the pixel circuit 21, a signal writing control line driving section (WSCN) 23, a current supply line driving section (DSCN) 25 and a horizontal selector (HSEL) 27 are used. The signal writing control line driving section 23 is used for on/off control of the sampling transistor T21. The current supply line driving section 25 is used to drive a current supply line DSL in a binary fashion to control the operation state of the pixel circuit.

The horizontal selector 27 is used to apply the signal potential Vsig corresponding to pixel data Din, a reference potential (hereinafter referred to as “first offset potential”) Vofs1 for threshold value correction or a reference potential (hereinafter referred to as “second offset potential”) Vofs2 for mobility correction to a signal line DTL.

It is to be noted that the second offset potential Vofs2 is set in advance as a fixed potential which corresponds to an intermediate gradation between the first offset potential Vofs1 and a maximum signal potential Vsig(max).

FIGS. 6A to 6E illustrate an example of driving operation of the pixel circuit 21 wherein the driving circuits mentioned are used.

First, an operation state of the pixel circuit in a light emitting state is illustrated in FIG. 7. Referring to FIG. 7, the current supply line DSL has the high potential Vcc, and the sampling transistor T21 is controlled to an off state as seen from time t1 of FIG. 6B. At this time, the driving transistor T22 is set so as to operate in a saturation region. Therefore, driving current Ids of a magnitude corresponding to the gate-source voltage Vgs of the driving transistor T22 is supplied to the organic EL element OLED.

Now, an operation state in a no-light emitting state is described. The no-light emitting state is started when the current supply line DSL is controlled to a low potential Vss as seen from time t2 of FIG. 6B. An operation state of the pixel circuit in this state is illustrated in FIG. 8. By the operation, the source potential Vs of the driving transistor T22 gradually drops. Thereupon, also the gate potential Vg of the driving transistor T22 drops through the coupling to the storage capacitor Cs.

It is to be noted that the low potential Vss is set lower than the sum of the threshold voltage Vthel and the cathode potential Vcat of the organic EL element OLED. Accordingly, at a point of time in the process wherein the source voltage Vs of the driving transistor T22 reaches the low potential Vss, the organic EL element OLED is turned off.

Thereafter, the sampling transistor T21 is controlled to an on state, and consequently, the first offset potential Vofs1 is applied to the gate electrode of the driving transistor T22 through the signal line DTL as seen from time t3 of FIG. 6D.

FIG. 9 illustrates an operation state of the pixel circuit at this point of time. Thereupon, the gate potential Vg of the driving transistor T22 is controlled to the first offset potential Vofs1 and the source potential Vs is controlled to the low potential Vss. In other words, the gate-source voltage Vgs of the driving transistor T22 is controlled to Vofs1−Vss.

It is to be noted that Vofs1−Vss is set to a value higher than the threshold voltage Vth of the driving transistor T22. With this operation, threshold value correction preparations are completed.

After the threshold value correction preparations are completed, the current supply line DSL is controlled to the high potential Vcc again as seen from time t4 of FIG. 6B. FIG. 10 illustrates an operation state of the image circuit at this point of time.

By this operation, current flows as indicated by a broken line in FIG. 10. It is to be noted that the organic EL element OLED can be equivalently represented by a diode and a parasitic capacitance Cel as seen in FIG. 10. Accordingly, as long as the anode voltage Vel of the organic EL element OLED remains lower than the sum of the threshold voltage Vthel and the cathode voltage Vcat of the organic EL element OLED, the current here is used to charge the storage capacitor Cs and the parasitic capacitance Cel.

By this charging operation, the source potential Vs of the driving transistor T22 begins to rise. FIG. 11 illustrates a manner of the rise of the source potential Vs. Here, at the point of time at which the source potential Vs reaches Vofs1−Vth, the threshold value correction operation of the driving transistor T22 ends.

FIGS. 6A to 6E illustrate the driving operation of the pixel circuit 21 where the threshold value correction operation ends within one horizontal scanning period within which the first offset potential Vofs1 is applied to the signal line DTL.

However, where the horizontal scanning period is short, it is necessary to execute the threshold value correction operation divisionally within a plural number of horizontal scanning periods. Naturally, the threshold value correction operation executes only within a period within which the first offset potential Vofs1 is applied, but is interrupted within any other period within which any other potential is applied to the signal line DTL.

It is to be noted that, while the threshold value correction operation is interrupted, the sampling transistor T21 is controlled to an off state and the gate electrode of the pixel circuit 21 is controlled to a free end. Also within this period, since the current supply line DSL is kept at the high potential Vcc, the gate potential Vg and the source potential Vs of the driving transistor T22 rise in an interlocking relationship with each other. However, since the reversely biased state of the organic EL element OLED, that is, Vel≦Vcat+Vthel, is maintained, the organic EL element OLED does not emit light.

Anyway, when the threshold value correction operation ends, the sampling transistor T21 is controlled to an off state until the potential of the signal line DTL varies to a potential suitable for the mobility correction as seen from time T5 of FIG. 6C.

Soon, when the potential of the signal line DTL varies to the second offset potential Vofs2 for mobility correction, the sampling transistor T21 is controlled to an on state as seen from time t6 of FIG. 6C.

It is to be noted that the on state of the sampling transistor T21 is maintained for a fixed period of time also after the potential of the signal line DTL is changed over to the signal potential Vsig.

By the application of the second offset potential Vofs2 and the signal potential Vsig, the gate-source voltage Vgs of the driving transistor T22 becomes wider than the threshold voltage Vth.

As a result, the driving transistor T22 operates into an on state again, and supply of current from the current supply line DSL is resumed. However, this current is used to charge the storage capacitor Cs and the parasitic capacitance Cel similarly as upon the threshold value correction operation. FIG. 13 illustrates a relationship between the elapsed time and the source potential Vs within the mobility correction period.

It is to be noted that, when the mobility correction operation starts, the threshold value correction operation of the driving transistor T22 has been completed. Accordingly, the current flowing through the driving transistor T22 exhibits a value which reflects only the mobility μ. In particular, the amount of current of the driving transistor T22 whose mobility μ is high increases and also the rise of the source potential Vs is accelerated.

On the other hand, the current amount of the driving transistor T22 whose mobility is low decreases, and the rise of the source potential Vs is decelerated.

Incidentally, during the mobility correction operation, the signal potential Vsig is used. Therefore, the correction time relies upon the signal potential Vsig. For example, upon white display within which the potential is high, the correction time is short, but upon black or dark display within which the potential is low, the correction time is long.

Accordingly, if it is tried to use only the signal potential Vsig to correct the mobility, then it becomes necessary to vary the correction time length in response to the signal potential Vsig.

However, in the case of the driving method of FIGS. 6A to 6E, since the second offset potential Vofs2 which is an intermediate potential between the first offset potential Vofs1 and the maximum signal potential Vsig(max) is applied before the signal potential Vsig is inputted, it is possible to line up the end timing of correction irrespective of the difference of the signal potential Vsig as seen from FIGS. 14A, 14B and 15A, 15B.

FIGS. 14A and 14B illustrate variations of the correction time where the second offset potential Vofs2 is not used and where the second offset potential Vofs2 is used, respectively, upon white display. It can be recognized that the mobility correction time is elongated by use of the second offset potential Vofs2.

FIGS. 15A and 15B illustrate variations of the correction time where the second offset potential Vofs2 is not used and where the second offset potential Vofs2 is used, respectively, upon black or dark display. It can be recognized that the mobility correction time is shortened by use of the second offset potential Vofs2.

Accordingly, whichever the gradation is, the mobility correction can be completed in substantially same time by using the second offset potential Vofs2 of a suitable magnitude.

After the correction operation ends, if the sampling transistor T21 is controlled to an off state, then driving current Ids′ of the driving transistor T22 flows to the organic EL element OLED and light emission of the organic EL element OLED is started as seen from time t7 of FIGS. 6A to 6E.

FIG. 16 illustrates an operation state of the pixel circuit at this point of time. It is to be noted that the source potential Vs of the driving transistor T22 rises to a voltage Vx corresponding to the value of driving current flowing to the organic EL element OLED.

Incidentally, also where the pixel circuit 21 shown in FIG. 5 is driven by the driving method illustrated in FIGS. 6A to 6E, when the light emitting time of the organic EL element OLED becomes long, the I-V characteristic thereof cannot be avoided from varying. However, in the case of the pixel circuit 21, since the gate-source voltage Vgs of the driving transistor T22 can be maintained at a value corresponding to the pixel data Din, if the pixel data Din is same, then normally constant current can be supplied to the organic EL element OLED irrespective of the lapse of time.

In other words, even if the I-V characteristic of the organic EL element OLED varies together with the aged deterioration, the luminance of the organic EL element OLED can be maintained to a fixed luminance corresponding to the pixel data Din.

However, the pixel circuit 21 has a problem in that luminance unevenness is likely to appear originating from the pixel structure thereof.

A cause of appearance of luminance unevenness is described with reference to FIG. 17. FIG. 17 principally shows a wiring line layout of the pixel circuit 21. As seen in FIG. 17, it is necessary for the width of the current supply line DSL used for supply of driving current to be greater than that of the signal line DTL or the writing control line WSL. As a result, it cannot be avoided that the intersecting area between the current supply line DSL and the signal line DTL becomes large.

However, since it seems from the horizontal selector 27 that the signal line DTL has a capacitance load, waveform distortion is likely to appear with the signal potential. Besides, the number of capacitance components to be driven by the horizontal selector 27 increases as the distance from the horizontal selector 27 increases. Therefore, the distortion of the signal waveform increases as the distance from the horizontal selector 27 increases as seen in FIG. 18.

This distortion makes a cause of providing a potential difference in the gate-source voltage Vgs between the near end side and the remote end side with respect to the horizontal selector 27 and causes a luminance difference to appear although the same gradation luminance is written. In other words, shading occurs. FIG. 19C shows a signal waveform of the gate potential Vg of the driving transistor T22, and FIG. 19D shows a signal waveform of the source potential Vs.

In each of FIGS. 19C and 19D, a broken line indicates the waveform of a pixel corresponding to a horizontal line positioned on the near end side with respect to the horizontal selector 27, and a solid line indicates the waveform of a pixel circuit corresponding to a horizontal line positioned on the remote end side with respect to the horizontal selector 27.

The potential difference after the writing of the signal potential Vsig ends makes a cause of appearance of shading on the screen image.

Therefore, it is demanded to provide a driving technique for an EL display panel which is less likely to suffer from shading.

According to an embodiment of the present invention, there is provided an EL display panel having a pixel structure ready for an active matrix driving method, including an input signal line driving section configured to output an intermediate potential Vofs2 for mobility correction, a threshold value correction potential Vofs1 and a signal potential Vsig corresponding to a gradation value in order for each horizontal scanning period, and a writing controlling driving section configured to have a control period for keeping an on state of a sampling transistor for controlling writing of the above described three potentials within a period beginning with a timing midway of an application period of the intermediate potential and ending with another point of time midway of an application period of the signal potential.

Preferably, the intermediate potential Vofs2 is higher than the threshold value correction potential Vofs1 but lower than a maximum potential of a variation range of the signal potential Vsig.

Preferably, the intermediate potential Vofs2 is successively produced based on the signal potential Vsig.

An EL display panel, wherein the intermediate potential Vofs2 may be produced through a mathematical operation process, through hardware processing or through a conversion process using a reference table.

Alternatively, the intermediate potential may be a fixed potential set in advance.

Preferably, the intermediate potential Vofs2, threshold value correction potential Vofs1 and signal potential Vsig are applied through a common input signal line.

According to another embodiment of the present invention, there is provided an electronic apparatus including an EL display which adopts a driving technique. The electronic apparatus includes an EL display panel, a system control section for controlling operation of the EL display panel, and an operation inputting section for accepting an operation input to the system control section.

In the EL display panel and the electronic apparatus, the intermediate potential Vofs2 for mobility correction, the threshold value correction potential Vofs1 and the signal potential Vsig are applied in order to the gate electrode of a driving transistor. Further, at a mobility correction timing within a no-light emitting period, the on state of the sampling transistor for controlling writing of the three potentials is kept within the period beginning with a timing midway of the application period of the intermediate potential Vofs2 and ending with another point of time midway of the application period of the signal potential Vsig.

According to the countermeasure described, mobility correction is executed within two periods between which the application period of the threshold correction potential Vofs1 is interposed. In this instance, whereas the first time mobility correction for a pixel circuit on the near end side to the input signal line driving section at which the distortion appearing with the waveform when the potential changes is comparatively small ends comparatively early, the second time mobility correction is started comparatively early. On the other hand, whereas the first time mobility correction for another pixel circuit on the remote end side at which the distortion appearing with the waveform when the potential changes is comparatively great ends relatively late, the second time mobility correction is started comparatively late.

Where the twice mobility correction periods are viewed as a whole, the correction time period for the pixel circuit on the near end side and the correction time period for the pixel circuit on the remote end side are substantially equal to each other. As a result, also where the magnitude of the distortion differs depending upon the position on the input signal line, the mobility correction is carried out accurately, and also writing of the signal potential is implemented accurately. Consequently, if the pixel data value is equal, then also the gradation luminance on the screen image can be made equal, and appearance of shading can be prevented.

### BRIEF DESCRIPTION OF THE DRAWINGS

FIG. 1 is a block diagram showing a functional configuration of an existing organic EL panel;

FIG. 2 is a block circuit diagram illustrating an existing connection relationship between a pixel circuit and driving circuits;

FIG. 3 is a diagram illustrating aged deterioration of the I-V characteristic of an organic EL element;

FIG. 4 is a block circuit diagram showing another example of an existing pixel circuit;

FIG. 5 is a block circuit diagram illustrating another example of a connection relationship between a pixel circuit and driving circuits;

FIGS. 6A to 6E are timing charts illustrating an example of driving operation for the pixel circuit shown in FIG. 5;

FIGS. 7 to 10 are circuit diagrams illustrating different operation states of the pixel circuit shown in FIG. 5;

FIG. 11 is a diagram illustrating aged deterioration of the source potential;

FIG. 12 is a circuit diagram illustrating a different operation state of the pixel circuit shown in FIG. 5;

FIG. 13 is a diagram illustrating a difference in aged deterioration by a difference in mobility;

FIGS. 14A and 14B are diagrams illustrating a mobility correction operation where the signal potential is high;

FIGS. 15A and 15B are diagrams illustrating a mobility correction operation where the signal potential is low;

FIG. 16 is a circuit diagram illustrating another different operation state of the pixel circuit shown in FIG. 5;

FIG. 17 is a circuit diagram illustrating a cause of appearance of luminance unevenness;

FIG. 18 is a block diagram illustrating distortion of a signal waveform in accordance with the pixel position;

FIGS. 19A to 19D are timing charts illustrating an influence of distortion of the signal waveform upon mobility correction;

FIG. 20 is a schematic view showing an appearance configuration of an organic EL panel;

FIG. 21 is a block circuit diagram illustrating a connection relationship between a pixel circuit and driving circuits;

FIG. 22 is a block circuit diagram showing an example of a configuration of a pixel circuit according to an embodiment 1 of the present invention;

FIG. 23 is a schematic diagrammatic view showing a signal waveform within a changing period adopted by the pixel circuit of FIG. 22;

FIGS. 24A to 24E are timing charts illustrating an example of driving operation by the pixel circuit of FIG. 22;

FIGS. 25 to 31 are circuit diagrams illustrating different operation states of the pixel circuit of FIG. 22;

FIG. 32 is a block circuit diagram illustrating another correction relationship between a pixel circuit and driving circuits;

FIG. 33 is a block circuit diagram showing an example of a configuration of a pixel circuit according to an embodiment 2 of the present invention;

FIG. 34 is a block diagram showing an example of a configuration of a horizontal selector shown in FIG. 33;

FIGS. 35A to 35E are timing charts illustrating an example of driving operation of the pixel circuit shown in FIG. 33;

FIGS. 36 to 41 are circuit diagrams illustrating different operation states of the pixel circuit of FIG. 33;

FIGS. 42A to 42E are timing charts illustrating operation states of the pixel circuit of FIG. 33 within a mobility correction period;

FIG. 43 is a circuit diagram illustrating a different operation state of the pixel circuit of FIG. 33;

FIG. 44 is a block diagram showing another example of the horizontal selector shown in FIG. 33;

FIGS. 45A to 45C are diagrams illustrating input/output relationships to be stored into a conversion table shown in FIG. 44;

FIG. 46 is a schematic view showing an example of an electronic apparatus; and

FIGS. 47, 48A and 48B, 49, 50A and 50B, and 51 are schematic views showing different examples of the electronic apparatus of FIG. 46 as a commodity.

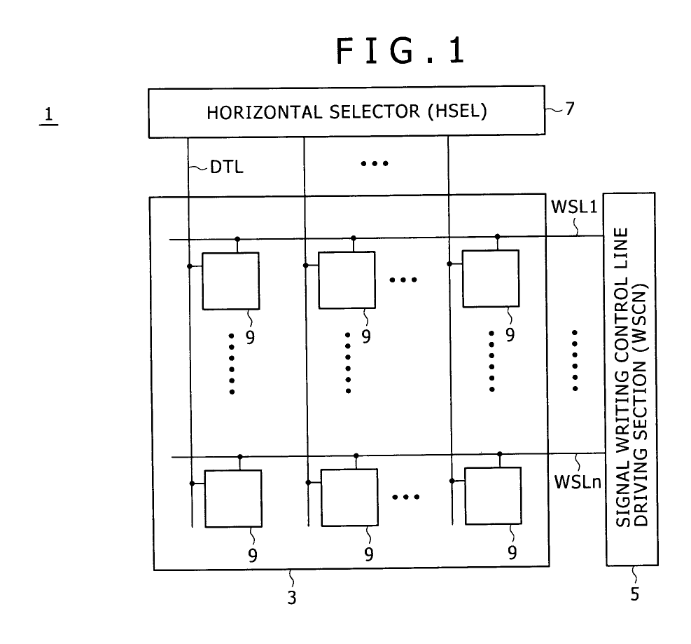

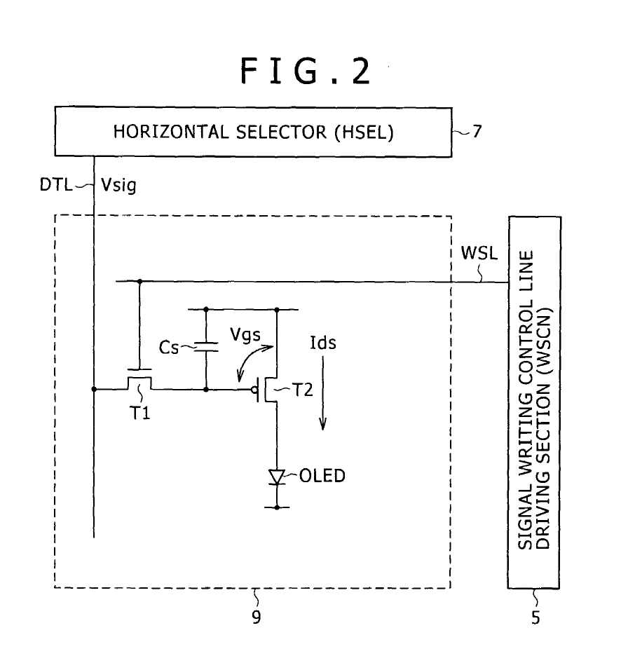

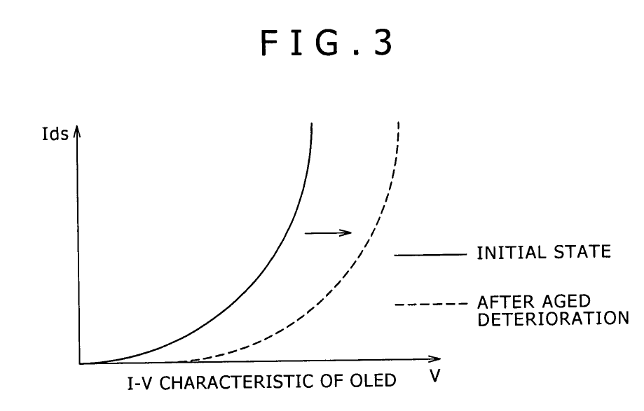

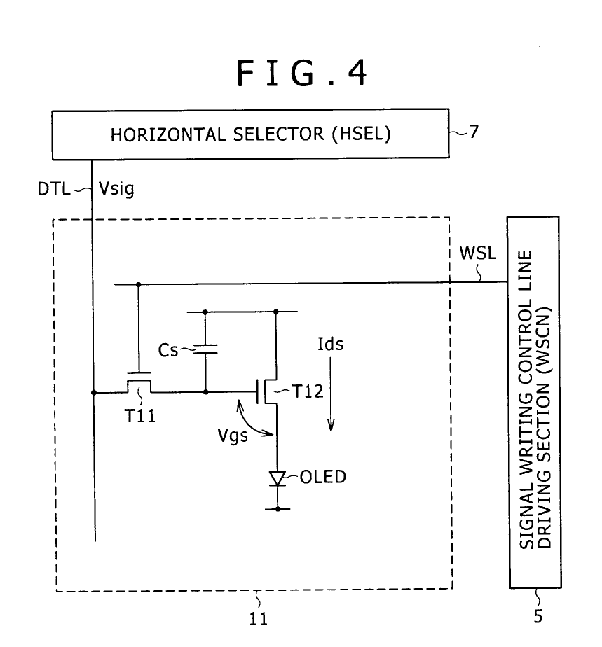

### DETAILED DESCRIPTION OF THE PREFERRED EMBODIMENTS

In the following, embodiments are described in connection with an EL display panel of the active matrix driving type to which the present invention is applied.

It is to be noted that, for technical matters which are not specifically described herein or specifically illustrated in the accompanying drawings, techniques which are known in the pertaining technical field are applied.

### A. Appearance Configuration

In the present specification, not only a display panel wherein a pixel array section and driving circuits are formed on the same substrate using a semiconductor process but also an apparatus wherein driving circuits fabricated, for example, as ICs for a particular application are mounted on a substrate on which a pixel array section is formed are individually referred to as organic EL panel.

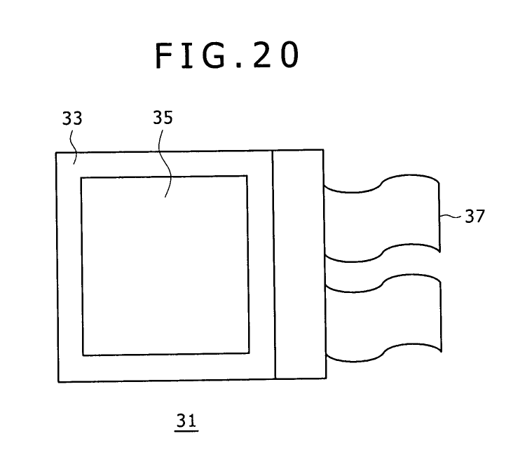

FIG. 20 shows an example of an appearance configuration of an organic EL panel. Referring to FIG. 20, the organic EL panel 31 shown is structured such that an opposing section 35 is adhered to a region of a support substrate 33 in which a pixel array section is formed.

The support substrate 33 is formed from a substrate of a glass material, a plastic material or some other material and is structured such that an organic EL layer, a protective layer and so forth are layered on the surface of the substrate. The opposing section 35 is formed from a substrate made of glass, plastics or some other transparent material. Further, flexible printed circuits (FPC) 37 for inputting and outputting signals and so forth to the support substrate 33 from the outside and vice versa are disposed on the organic EL panel 31.

### B. Embodiment 1

### B-1. System Configuration

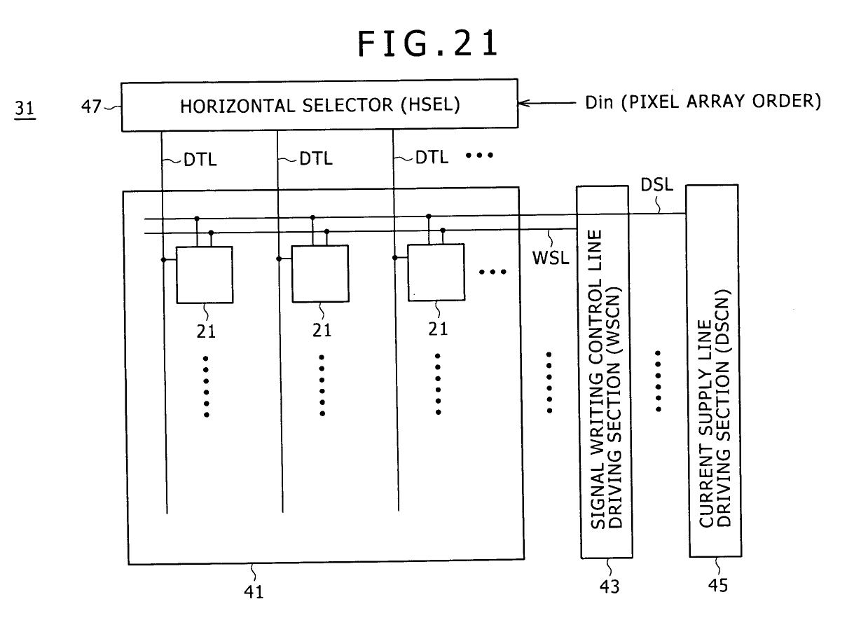

FIG. 21 shows an example of a system configuration of the organic EL panel 31 according to an embodiment 1 of the present invention.

Referring to FIG. 21, the organic EL panel 31 shown includes a pixel array section 41, and a signal writing control line driving section (WSCN) 43, a current supply line driving section (DSCN) 45 and a horizontal selector (HSEL) 47 which serve as driving circuits for the pixel array section 41.

The pixel array section 41 has a matrix structure wherein a sub pixel is disposed at each of intersecting points of signal lines DTL and writing control lines WSL. Incidentally, a sub pixel is a minimum unit of a pixel structure which forms one pixel. For example, one pixel as a white unit is formed from three sub pixels (R, G, B) made of different organic EL materials.

The signal line DTL here is one of “input signal lines.” Meanwhile, the writing control line WSL is one of control signal lines.

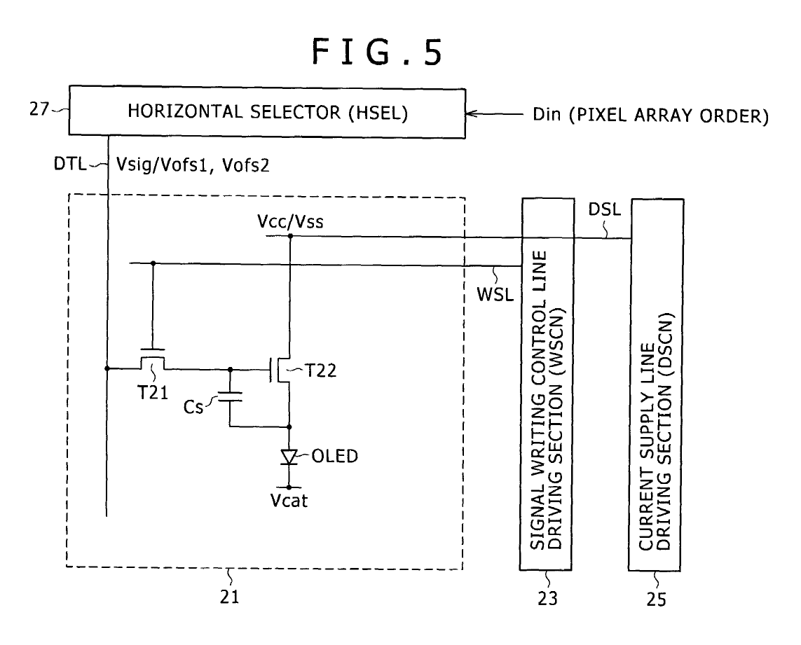

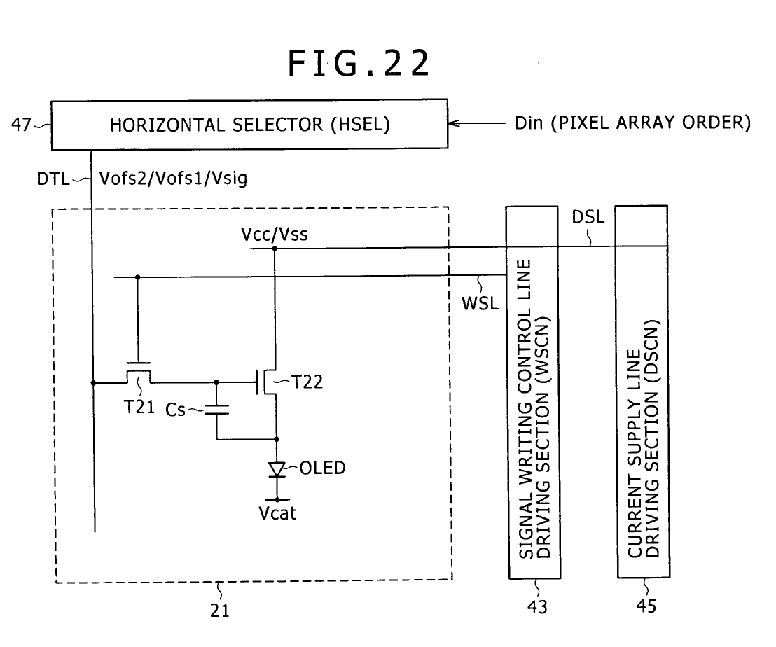

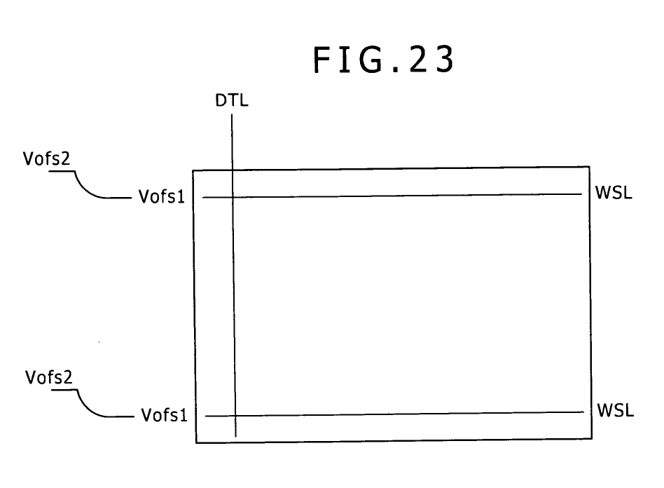

FIG. 22 shows a connection relationship between a pixel circuit 21 corresponding to a sub pixel and the driving circuits. Referring to FIG. 22, the pixel circuit 21 shown has a configuration same as that described hereinabove with reference to FIG. 5. In particular, the pixel circuit 21 includes an N-channel sampling transistor T21, an N-channel driving transistor T22 and a storage capacitor Cs.

Accordingly, the sampling transistor T21 operates as a switch for controlling writing of a signal potential Vsig, and the driving transistor T22 operates as a constant current source for supplying driving current to the organic EL element OLED when the organic EL element OLED operates to emit light.

However, the pixel circuit 21 is driven by a different driving method from that of the pixel circuit 21 shown in FIG. 5.

In the present embodiment, a signal writing control line driving section (WSCN) 43, a current supply line driving section (DSCN) 45 and a horizontal selector (HSEL) 47 are used for driving of the pixel circuit 21. The signal writing control line driving section 43 is used for on/off control of the sampling transistor T21. The current supply line driving section 45 is used for binary potential driving of the current supply line DSL.

The horizontal selector 47 is used to apply a signal potential Vsig corresponding to a gradation value of pixel data Din, a reference potential (hereinafter referred to as “first offset potential”) Vofs1 for threshold value correction or a reference potential (hereinafter referred to as “second offset potential”) Vofs2 for mobile correction to the signal line DTL.

It is to be noted that the first offset potential Vofs1 corresponds to a “threshold value correction potential.” Meanwhile, the second offset potential Vofs2 corresponds to a “mobility correction intermediate potential.”

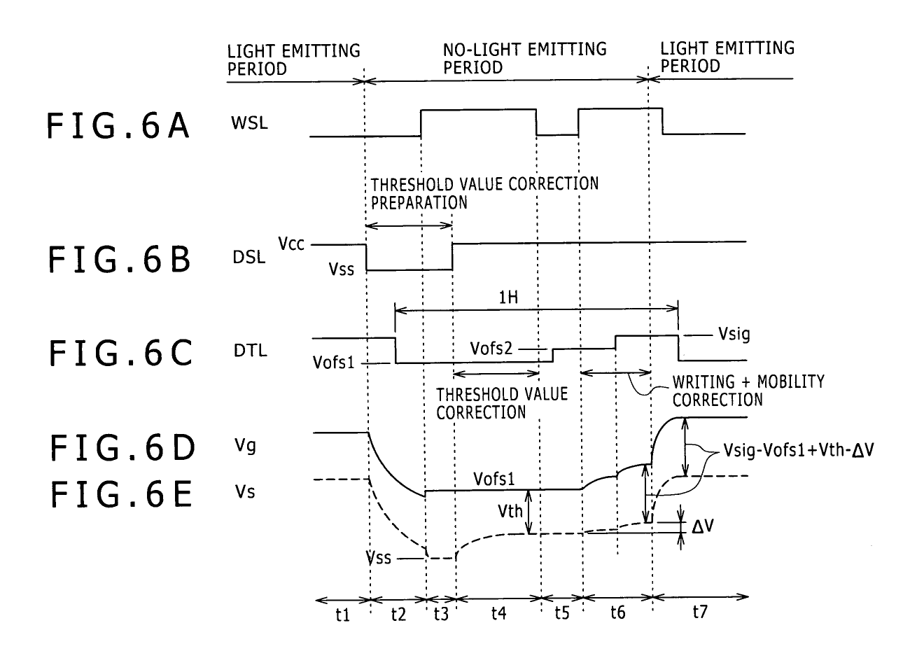

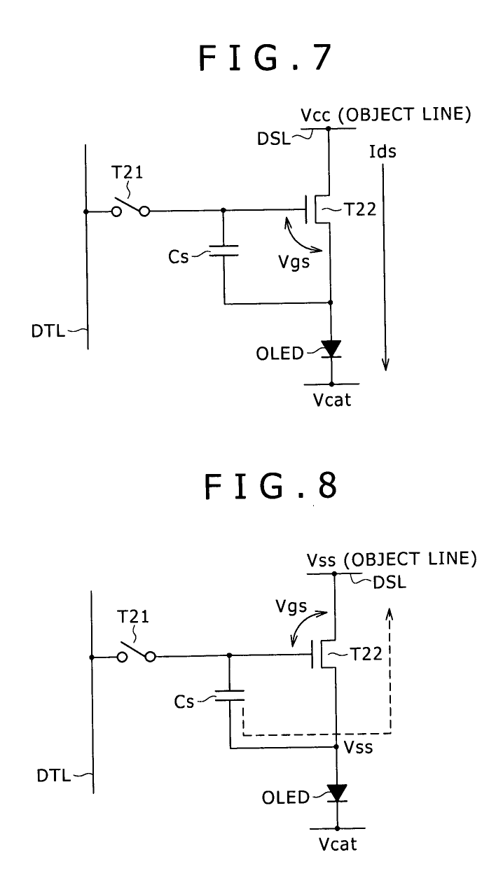

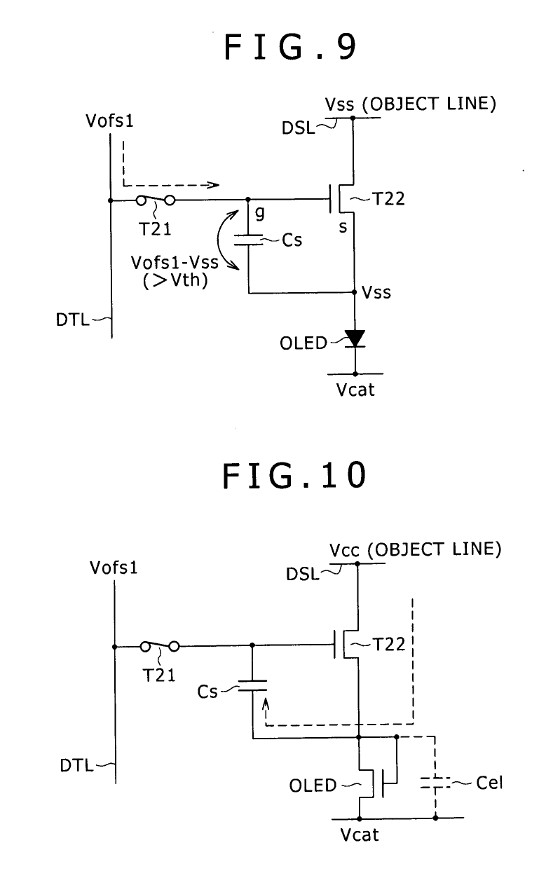

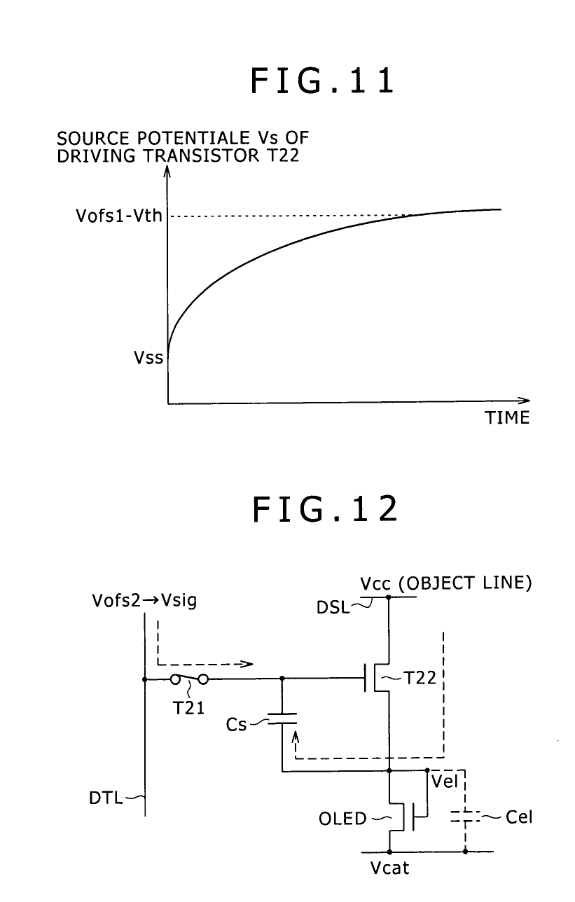

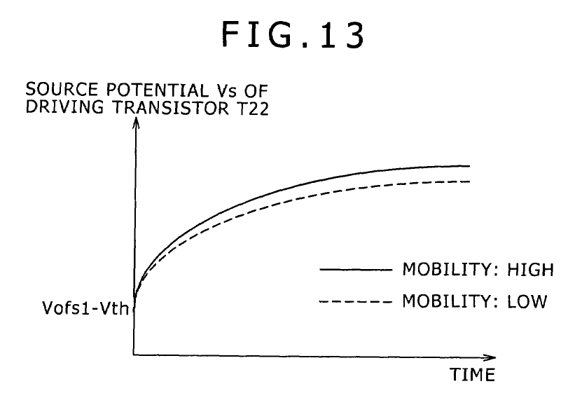

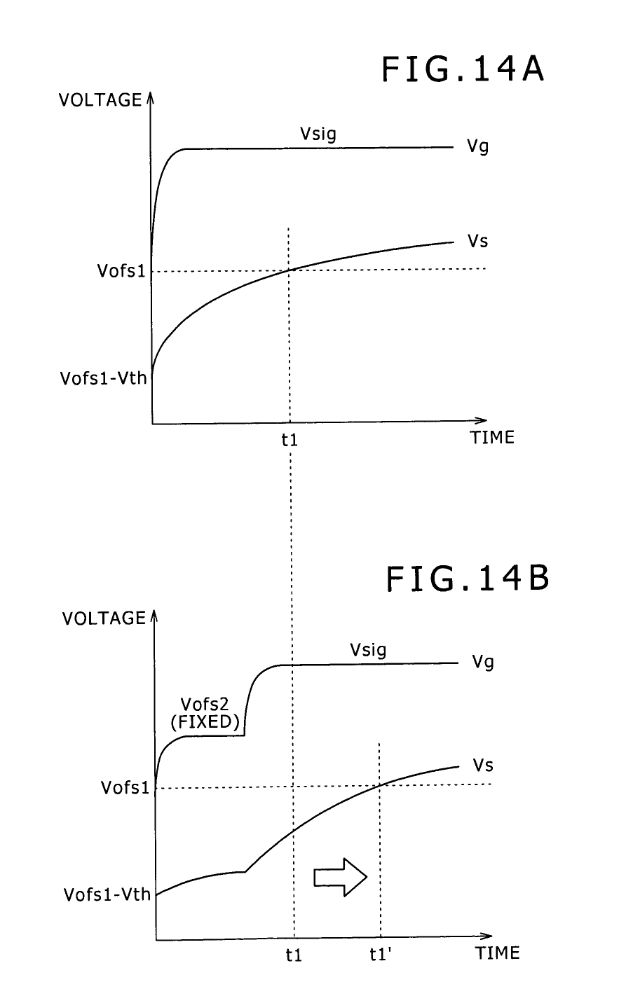

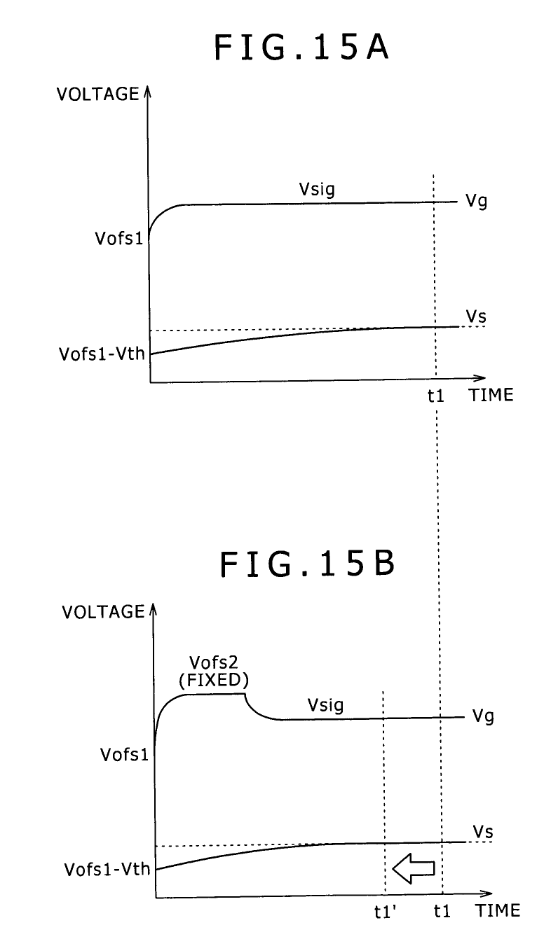

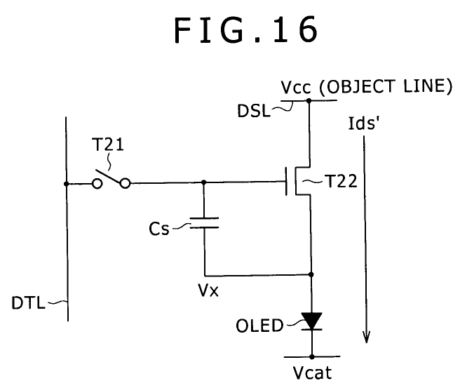

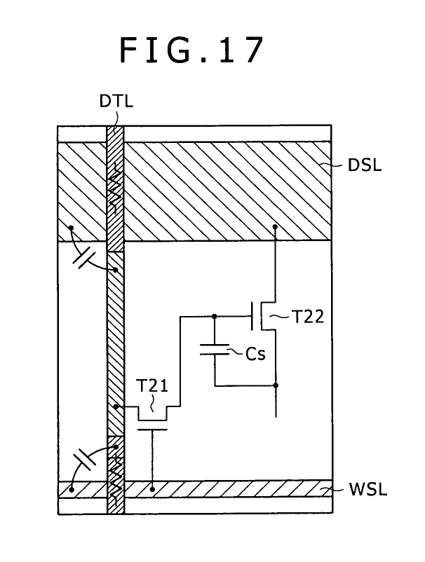

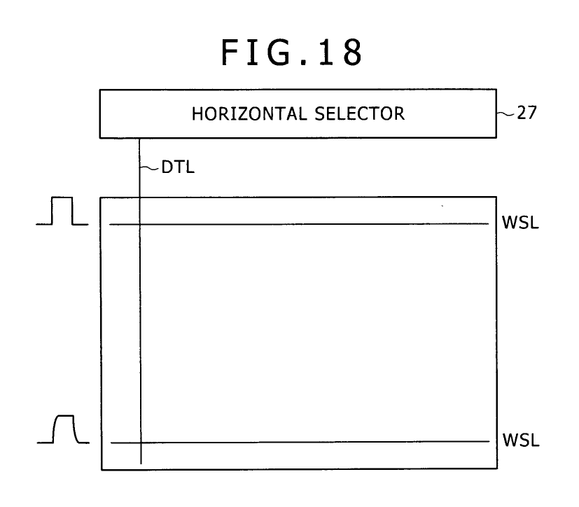

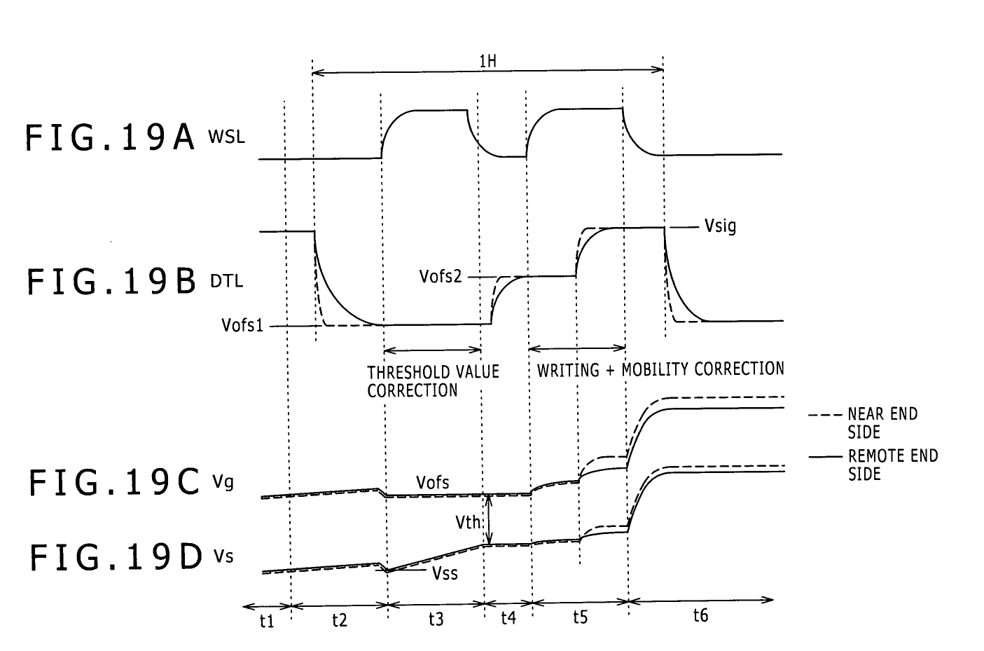

The kinds of the potential to be applied are same as those in the driving method described hereinabove with reference to FIGS. 6A to 6E.

The driving method is different in the outputting order of the potentials. The horizontal selector 47 controls the potential of the signal line DTL in order of the second offset potential Vofs2→first offset potential Vofs1→signal potential Vsig within one horizontal scanning period.

Further, in the present embodiment, the horizontal selector 47 adopts a technique of intentionally distorting the transition waveform of the potential from the second offset potential Vofs2 to the first offset potential Vofs1. For example, a switch and a low-pass filter are disposed at an output stage of the horizontal selector 47 and are controlled such that, only when the first offset potential Vofs1 is to be outputted, the signal line DTL is driven through the low-pass filter to produce an intended waveform.

If the output waveform of the first offset potential Vofs1 is intentionally distorted in this manner, then the potential having the distorted waveform is applied also to the pixel circuit 21 on the near end side of the horizontal selector 47.

Naturally, since the potential of the distorted waveform is applied also to the pixel circuit 21 on the remote end side, the distortion manners of the potential are substantially same. This signifies that, even if the position on the signal line DTL is different, the gate potential Vg or the source potential Vs of the drive transistor T21 when a first time mobility correction operation is completed can be controlled to a substantially same potential.

It is to be noted that, when the second offset potential Vofs2 or the signal potential Vsig is to be outputted, the output path which does not involve the low-pass filter should be selected.

### B-2. Example of Driving Operation

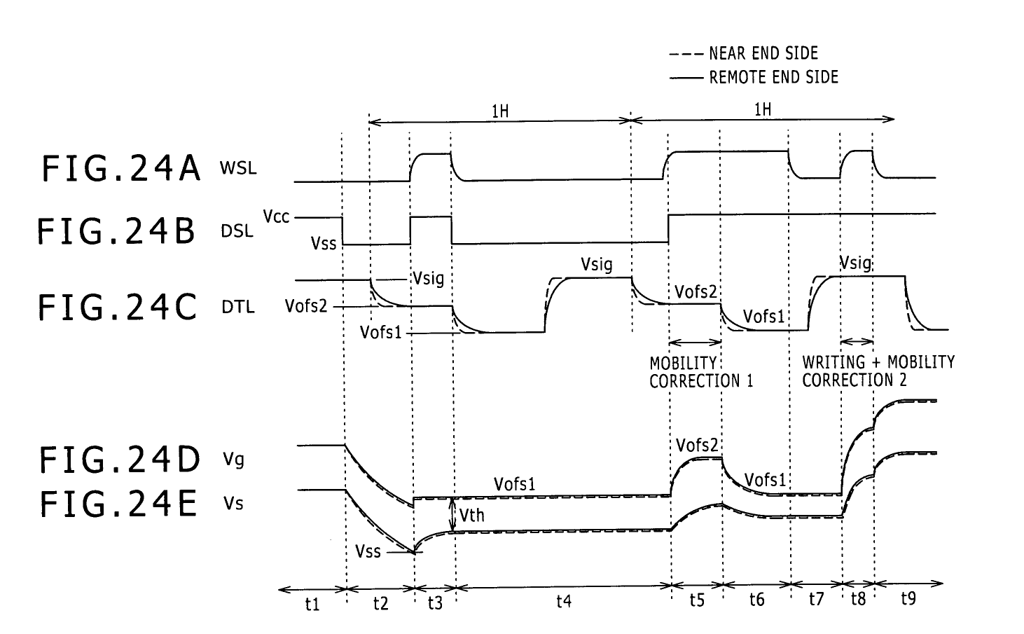

FIGS. 24A to 24E illustrate an example of driving operation of the pixel circuit shown in FIG. 22.

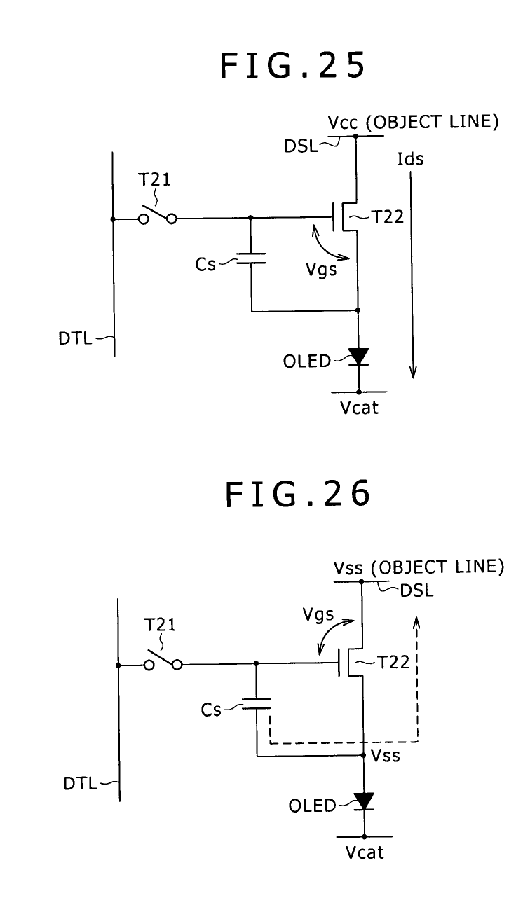

An operation state of the pixel circuit in a light emitting state is illustrated in FIG. 25. At this time, the current supply line DSL has the high potential Vcc and the switching transistor T1 is controlled to an off state as seen from time t1 of FIG. 24B.

At this time, the driving transistor T22 operates in a saturation region thereof.

Therefore, driving current Ids of a magnitude corresponding to the gate-source voltage Vgs of the driving transistor T22 is supplied to the organic EL element OLED.

Now, an operation state in a no-light emitting state of the pixel circuit is described. The no-light emitting state is started as the current supply line DSL is controlled to the low potential Vss as seen from time t2 of FIG. 24C. An operation state of the pixel circuit in this state is illustrated in FIG. 26. By the operation, the source potential Vs of the driving transistor T22 gradually drops. Thereupon, also the gate potential Vg of the driving transistor T22 drops through the coupling with the storage capacitor Cs.

It is to be noted that the low potential Vss is set to a value lower than the sum of the threshold voltage Vthel and the cathode voltage Vcat of the organic EL element OLED. Accordingly, the organic EL element OLED is turned off in the process until the source potential Vs of the driving transistor T22 reaches the low potential Vss.

Thereafter, the sampling transistor T21 is controlled to an on state and the gate-source voltage Vgs of the driving transistor T22 is set to Vofs1−Vss. This setting operation is a threshold value correction preparation operation. Then, after the threshold value correction preparation operation is completed, the current supply line DSL is controlled to the high potential Vcc again as seen from time t3 in FIG. 24B.

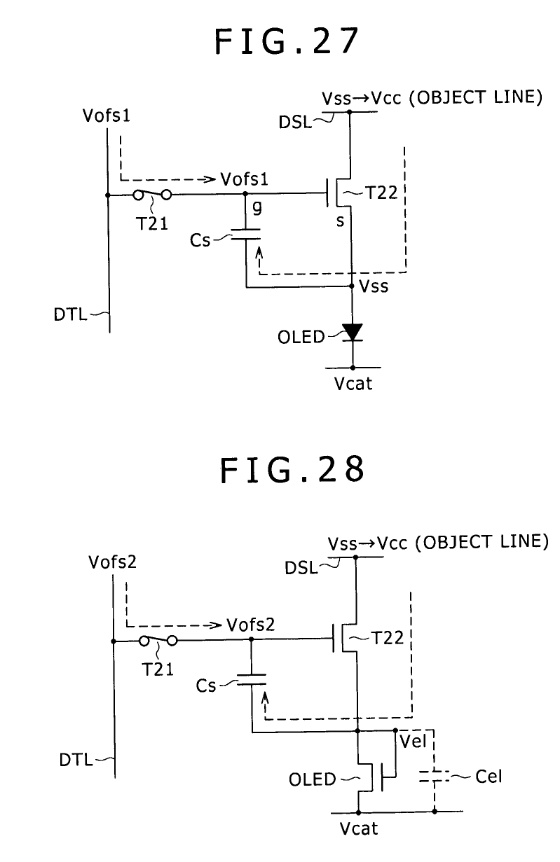

FIG. 27 illustrates an operation state of the pixel circuit at this point of time. It is to be noted that the timing at which the sampling transistor T21 is controlled to an on state is optimized taking the distortion of the potential of the signal line DTL into consideration. In particular, not only for the signal line potential on the side near to the horizontal selector 47 but also for the signal line on the remote side from the horizontal selector 47, the timing at which the sampling transistor T21 is controlled to an on state is set to a point of time later than the point of time at which the signal potential converges to the first offset potential Vofs1.

Then, when the current supply line DSL is controlled to the high potential Vcc, current begins to flow from the current supply line DSL to the driving transistor T22. However, the current is used to charge the storage capacitor Cs and the parasitic capacitance Cel. By the charging operation, the source potential Vs of the driving transistor T22 begins to rise.

In the present embodiment, the gate-source voltage Vgs of the driving transistor T22 converges to the threshold voltage Vth within one horizontal scanning period within which the first offset potential Vofs1 is applied, and thereupon, the threshold value correction operation of the driving transistor T22 ends. In other words, the driving transistor T22 is cut off. Naturally, where the horizontal scanning period is short, the threshold value correction operation is executed divisionally within a plurality of horizontal scanning periods. Naturally, the threshold value correction operation is executed at a timing at which the first offset potential Vofs1 is applied to the signal line DTL.

After the threshold value correction operation ends, the sampling transistor T21 is controlled to an off state until after the potential of the signal line DTL varies to a potential suitable for mobility correction, that is, to the second offset potential Vofs2. Also the potential of the current supply line DSL is controlled so as to be changed over to the low potential Vss as seen from time t4 in FIGS. 24C and 24B.

Soon, when the potential of the signal line DTL varies to the second offset potential Vofs2 for mobility correction, the sampling transistor T21 is controlled to an on state again as seen from time t5 of FIG. 24C. Also here, the timing at which the sampling transistor T21 is controlled to an on state is optimized taking the distortion of the potential of the signal line DTL into consideration.

Further, at the timing at which the signal line DTL is controlled to an on state, also the potential of the current supply line DSL is changed over to the high potential Vcc. FIG. 28 illustrates an operation state of the pixel circuit at this point of time.

By the application of the second offset potential Vofs2, the gate-source voltage Vgs of the driving transistor T22 becomes wider than the threshold voltage Vth, and the driving transistor T22 enters an on state again.

In particular, supply of current from the current supply line DSL into the pixel circuit is resumed and a first time mobility correction operation is started. The current here reflects the mobility μ of the driving transistor T22 and flows so as to charge the storage capacitor Cs and the parasitic capacitance Cel.

Soon, the potential of the signal line DTL changes to the first offset potential Vofs1 as seen from time t6 of FIG. 24C in a state wherein the sampling transistor T21 is on and the potential of the current supply line DSL is the high potential Vcc.

However, the change of the potential to the first offset potential Vofs1 is executed with a potential waveform distorted in advance. As a result, the gate potential Vg of the driving transistor T22 changes to the first offset potential Vofs1 at the same timing irrespective of whether the driving transistor T22 is positioned on the near end side or the remote end side with respect to the horizontal selector 47.

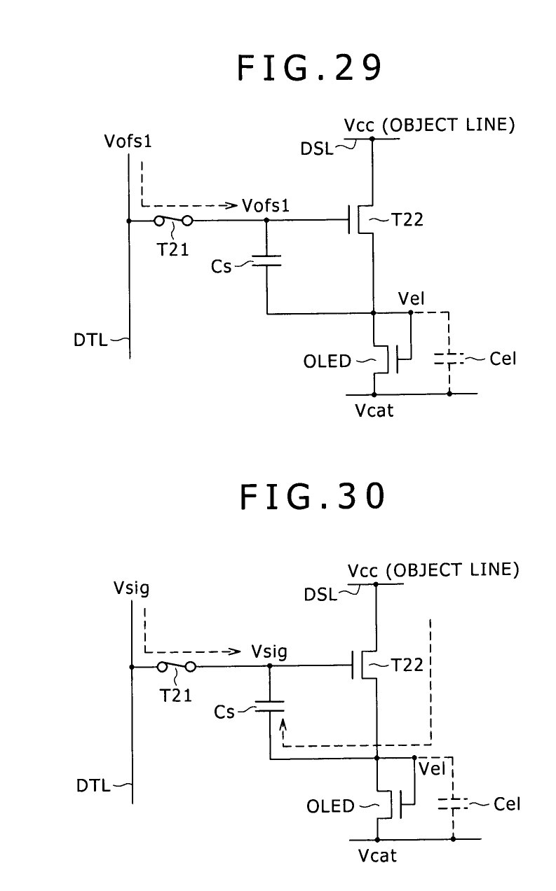

It is to be noted that the source potential Vs of the driving transistor T22 becomes higher than the potential thereof before the execution of the correction operation by the first time mobility correction operation. Accordingly, by the application of the first offset potential Vofs1, the gate-source voltage Vgs of the driving transistor T22 becomes lower than the threshold voltage Vth. As a result, the driving transistor T22 enters a cutoff state while it maintains the source potential Vs. FIG. 29 illustrates an operation state of the pixel circuit at this point of time.

After this timing, the sampling transistor T21 is controlled to an off state and prepares for writing of the signal potential Vsig as seen from time t7 of FIG. 24D.

Soon, when the signal potential Vsig is applied to the signal line DTL, the sampling transistor T21 is controlled to an on state again and a second time mobility correction operation is started in such a manner as to take over the first time mobility correction operation as seen from time t8 of FIG. 24C.

It is to be noted, however, that the timing at which the sampling transistor T21 is controlled to an on state is optimized taking the distortion of the potential of the signal line DTL into consideration. In particular, not only for the signal line potential on the side near to the horizontal selector 47 but also for the signal line on the remote side from the horizontal selector 47, the sampling transistor T21 is controlled to an on state at a timing later than the timing at which the signal potential converges to the signal potential Vsig. Accordingly, the signal potential Vsig of a correction value is written without being influenced by the position in the screen image. FIG. 30 illustrates an operation state of the pixel circuit at this point of time.

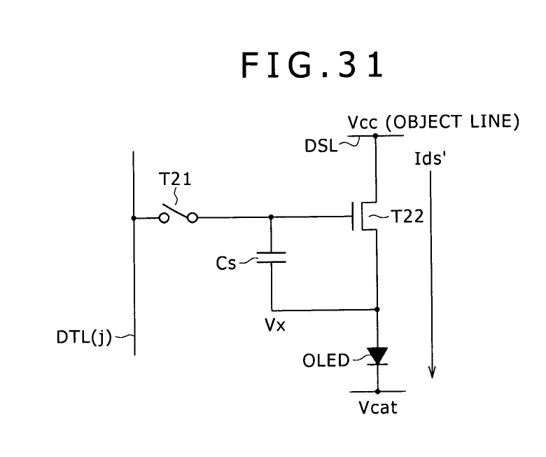

Finally, when the sampling transistor T21 is controlled to an off state to end the writing of the signal potential, supply of driving current Ids′ of a magnitude corresponding to the gate-source voltage Vgs of the driving transistor T22 to the organic EL element OLED is started. Consequently, emission of light from the organic EL element OLED is started as seen from time t9 of FIGS. 24D and 24E. FIG. 31 illustrates an operation state of the pixel circuit at this point of time.

Together with this, the anode voltage Vel of the organic EL element OLED, that is, the source potential Vs of the driving transistor T22, rises to a voltage Vx with which the driving current Ids′ is supplied to the organic EL element OLED.

This is the driving operation of the driving circuits provided by the present embodiment. Naturally, also in the present driving method, as the light emission time becomes long, the I-V characteristic of the organic EL element OLED varies.

However, the amount of current supplied to the organic EL element OLED is normally determined by the gate-source voltage Vgs of the driving transistor T22. As a result, irrespective of the variation of the I-V characteristic of the organic EL element OLED, the luminance of emitted light of the organic EL element OLED can be kept at a luminance corresponding to the signal potential Vsig.

### B-3. Summary

As described above, the present embodiment adopts a combination of (1) the method wherein the signal line DTL is driven in order with the second offset potential Vofs2, first offset potential Vofs1 and signal potential Vsig and a mobility correction operation is executed divisionally twice and (2) the method wherein the changing waveform of the potential from the second offset potential Vofs2 to the first offset potential Vofs1 is distorted intentionally.

Consequently, the mobility correction can be executed accurately in the same condition irrespective of whether the pixel circuit 21 is positioned near to the horizontal selector 47 or remotely from the horizontal selector 47.

As a result, appearance of shading can be suppressed effectively, and improvement of the picture quality can be implemented.

### C. Embodiment 2

Here, a driving technique ready for speeding up of a driving timing is described. As described hereinabove, the driving technique according to the embodiment 1 is effective in suppression of shading.

However, it is necessary to output the potential change from the second offset potential Vofs2 to the first offset potential Vofs1 in an intentionally distorted state, and therefore, the circuit configuration of the horizontal selector 47 is complicated.

Further, where the signal waveform is outputted in an intentionally distorted state, it is necessary to secure the period for the change, and where it is demanded to achieve further reduction of one horizontal scanning period together with achievement of a higher resolution, there is the possibility that incorporation into a product may become difficult.

Therefore, the following technique is proposed.

### C-1. System Configuration

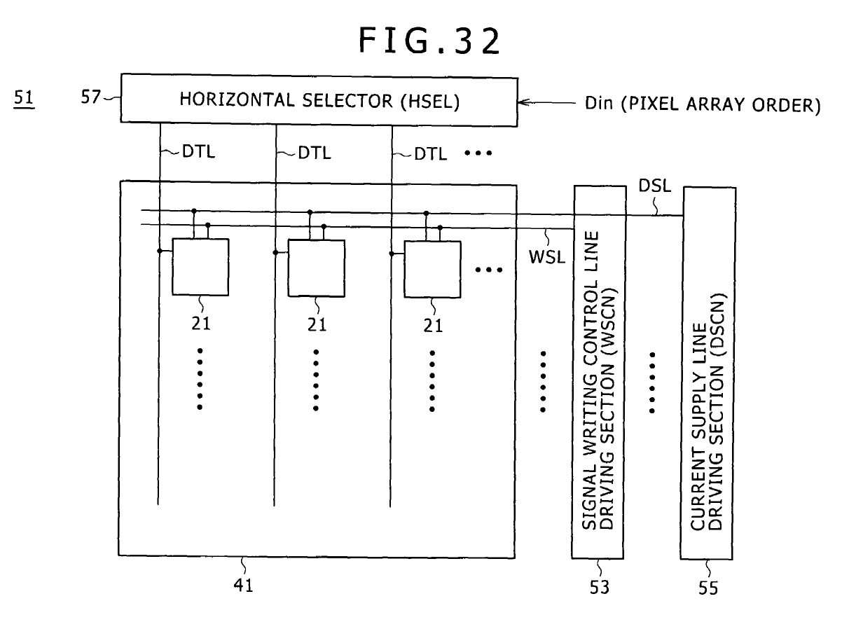

FIG. 32 shows an example of a system configuration of an organic EL panel 51.

Referring to FIG. 32, the organic EL panel 51 shown includes a pixel array section 41, and a signal writing control line driving section (WSCN) 53, a current supply line driving section (DSCN) 55 and a horizontal selector (HSEL) 57 which are driving circuits for the organic EL panel 51.

The pixel array section 41 has a structure same as that in the embodiment 1. In particular, the pixel array section 41 has a matrix structure wherein a sub pixel is disposed at each of intersecting points of signal lines DTL and writing control lines WSL.

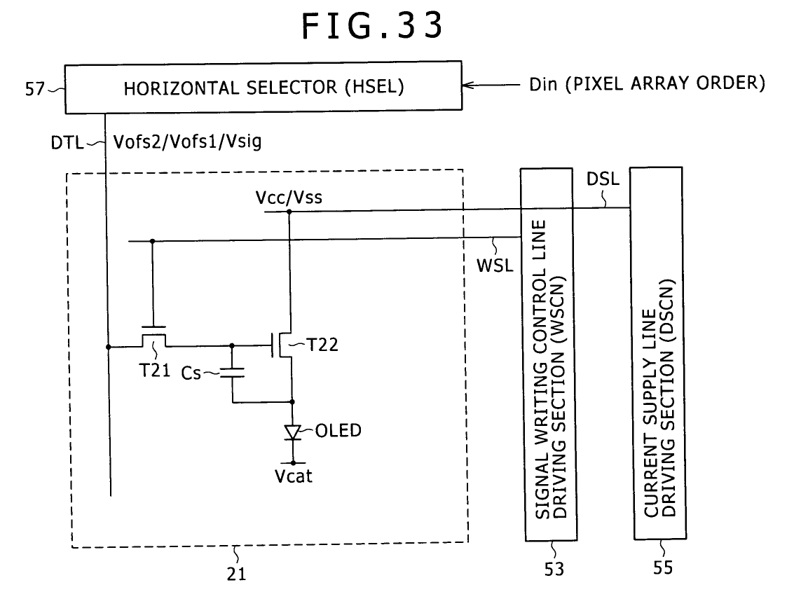

FIG. 33 illustrates a connection relationship between a pixel circuit 21 corresponding to a sub pixel and the driving circuits. Referring to FIG. 33, the pixel circuit 21 has a configuration same as that described hereinabove with reference to FIG. 22. In particular, the pixel circuit 21 includes an N-channel sampling transistor T21, an N-channel driving transistor T22 and a storage capacitor Cs.

Accordingly, the sampling transistor T21 operates as a switch for controlling writing of the signal potential Vsig, and the driving transistor T22 operates as a constant current source for supplying driving current when an organic EL element OLED operates to emit light.

However, the pixel circuit 21 is driven by a different driving method from that of the pixel circuit 21 shown in FIG. 22.

In the present embodiment, the signal writing control line driving section 53, current supply line driving section 55 and horizontal selector 57 are used for driving of the pixel circuit 21. In particular, the signal writing control line driving section 53 is used for on/off control of the sampling transistor T21. The current supply line driving section 55 is binary potential driving of the current supply line DSL.

The horizontal selector 57 is used to apply a signal potential Vsig corresponding to a gradation value of pixel data Din, a reference potential for threshold value correction (hereinafter referred to as “first offset potential”) Vofs1 or a reference potential for mobility correction (hereinafter referred to as “second offset potential”) Vofs2 to the signal line DTL. The types of the potentials to be applied are same as those in the driving method in the embodiment 1. In the present embodiment, a fixed potential is applied as the second offset potential Vofs2. For example, where a maximum potential is represented by Vsig(max), the fixed potential is given by {Vsig(max)−Vofs1}/2.

Also in the present embodiment, the outputting order of the three potentials is same as that in the embodiment 1. In particular, the horizontal selector 57 controls the potential of the signal line DTL in order to the second offset potential Vofs2→first offset potential Vofs1→signal potential Vsig within one horizontal scanning period.

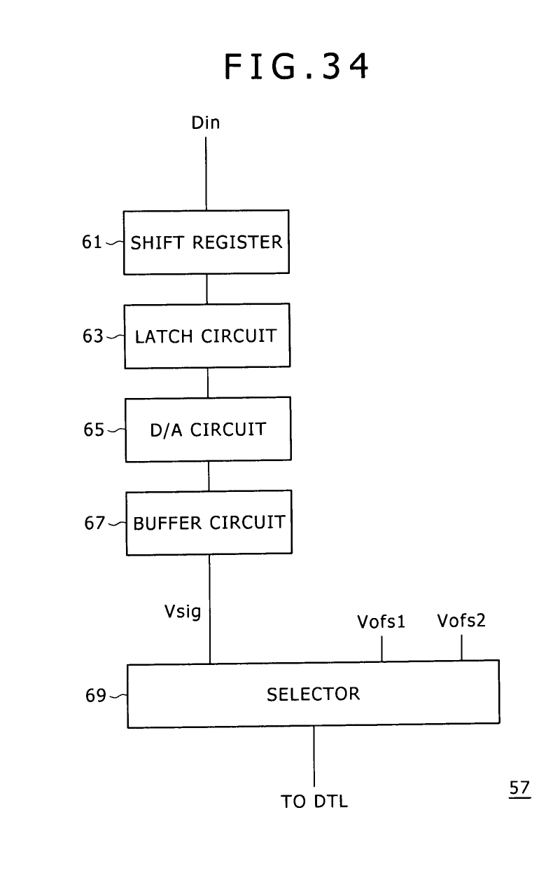

The present embodiment is different from the embodiment 1 in that the horizontal selector 57 outputs the potentials in the form of a rectangular signal wave. FIG. 34 shows an example of a configuration of the horizontal selector 57. Referring to FIG. 34, the horizontal selector 57 includes a shift register 61, a latch circuit 63, a D/A (digital to analog) conversion circuit 65, a buffer circuit 67 and a selector 69.

The shift register 61 is a circuit device for providing an inputting timing of the pixel data Din. The latch circuit 63 is a storage device for storing the pixel data Din for adjustment of the output timing. The D/A conversion circuit 65 is a circuit device for converting a digital signal inputted thereto into an analog signal.

The buffer circuit 67 is a circuit device for converting the analog signal into a signal of a signal level suitable for driving of a pixel circuit.

The selector 69 is a switch for switching the connection between the signal line DTL and the three different input potentials. The selector 69 connects the second offset potential Vofs2, first offset potential Vofs1 and signal potential Vsig in order to a signal line DTL within one horizontal scanning period.

As described hereinabove, the selector 69 does not have a mechanism for intentionally distorting the changeover waveform of the output potential. Accordingly, upon changeover of the potential level, distortion of a magnitude corresponding to the distance from the selector 69 is superposed on the potential on the signal line DTL. In other words, while distortion of a small waveform appears near the selector 69, distortion of a large waveform appears remotely from the selector 69.

### C-2. Example of Driving Operation

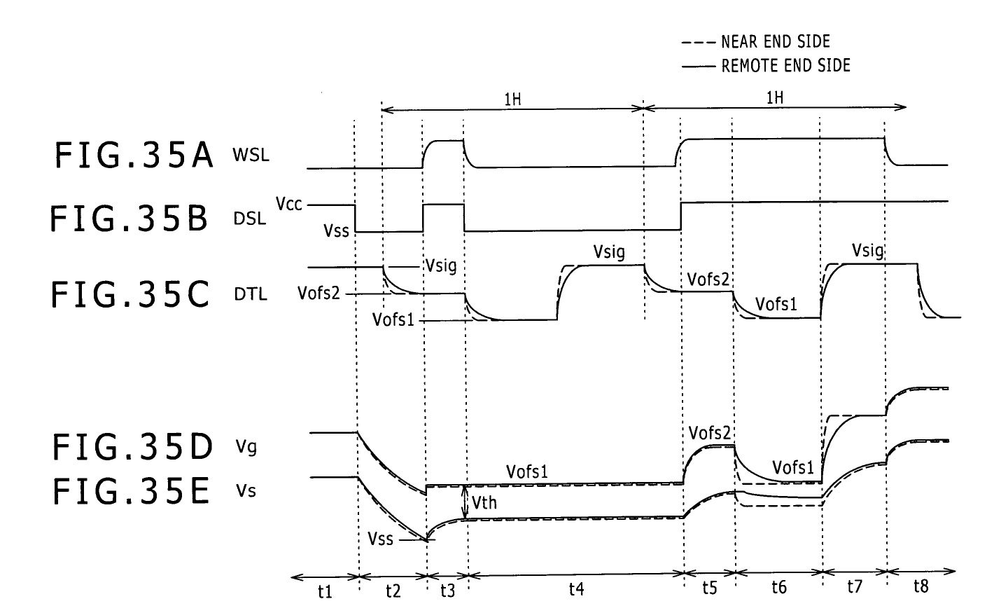

FIGS. 35A to 35E illustrate an example of driving operation for the pixel circuit shown in FIG. 33.

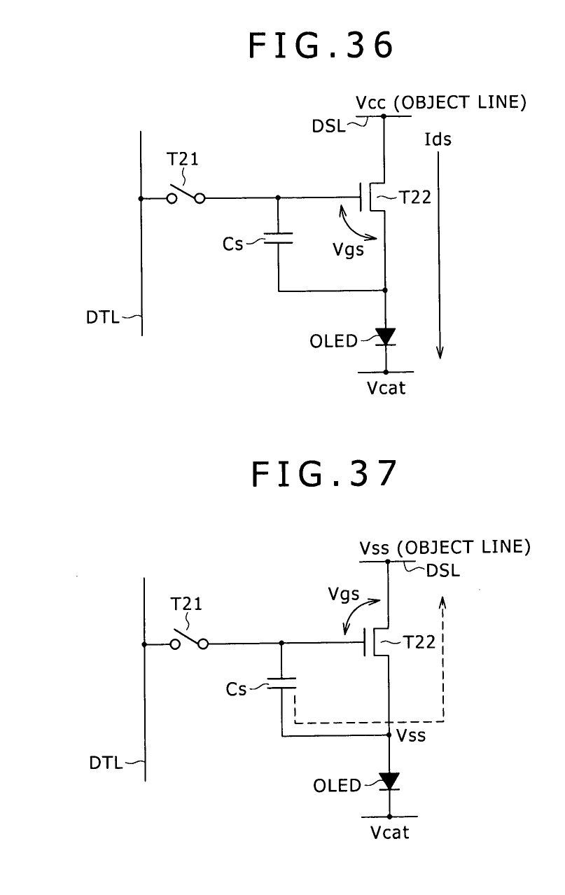

An operation state of the pixel circuit in a light emitting state is illustrated in FIG. 36. At this time, the current supply line DSL has the high potential Vcc, and the switching transistor T21 is controlled to an off state as seen from time t1 of FIG. 35C.

At this time, the driving transistor T22 operates in a saturation region.

Therefore, driving current Ids of a magnitude corresponding to the gate-source voltage Vgs of the driving transistor T22 is supplied to the organic EL element OLED.

Now, an operation state in a no-light emitting state is described. The no-light emitting state is started when the current supply line DSL is controlled to the low potential Vss as seen from time t2 of FIG. 35B. FIG. 37 illustrates an operation state of the pixel circuit at this point of time. By this operation, the source potential Vs of the driving transistor T22 gradually drops. Thereupon, also the gate potential Vg of the driving transistor T22 drops through the coupling thereof with the storage capacitor Cs.

It is to be noted that the low potential Vss is set lower than the sum of the threshold voltage Vthel and the cathode voltage Vcat of the organic EL element OLED. Accordingly, the organic EL element OLED is turned off in the process until the source potential Vs of the driving transistor T22 reaches the low potential Vss.

Thereafter, the sampling transistor T21 is controlled to an on state, and the gate-source voltage Vgs of the driving transistor T22 is set to Vofs1−Vss. This setting operation is a threshold value correction preparation operation. Then, after the threshold value correction preparation operation is completed, the current supply line DSL is controlled to the high potential Vcc again as seen from time t3 of FIG. 35B.

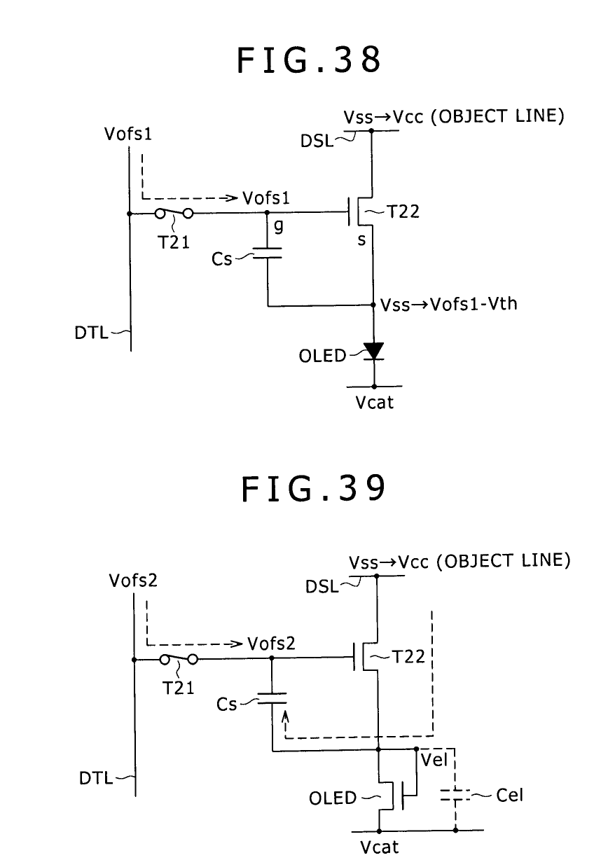

FIG. 38 illustrates an operation state of the pixel circuit at this point of time. It is to be noted that the timing at which the sampling transistor T21 is controlled to an on state is optimized taking the distortion of the potential of the signal line DTL into consideration. In particular, not only for the signal line potential on the side near to the horizontal selector 57 but also for the signal line on the remote side from the horizontal selector 57, the timing at which the sampling transistor T21 is controlled to an on state is set to a point of time later than the point of time at which the signal potential converges to the first offset potential Vofs1.

Then, when the current supply line DSL is controlled to the high potential Vcc, current begins to flow from the current supply line DSL to the driving transistor T22. However, the current is used to charge the storage capacitor Cs and the parasitic capacitance Cel. By this charging operation, the source potential Vs of the driving transistor T22 begins to rise.

In the case of the present embodiment, the gate-source voltage Vgs of the driving transistor T22 converges to the threshold voltage Vth and the threshold value correction operation of the driving transistor T22 ends within one horizontal scanning period within which the first offset potential Vofs1 is applied. In other words, the driving transistor T22 is cut off. Naturally, where the horizontal scanning period is short, the threshold value correction operation is executed divisionally within a plurality of horizontal scanning periods. Naturally, the threshold value correction operation is executed at a timing at which the first offset potential Vofs1 is applied to the signal line DTL.

When the threshold value correction operation ends, the sampling transistor T21 is controlled to an off state until after the potential of the signal line DTL varies to a potential suitable for mobility correction, that is, to the second offset potential Vofs2. Also the potential of the current supply line DSL is controlled so as to be changed over to the low potential Vss as seen from time t4 of FIG. 35B.

Soon, when the potential of the signal line DTL varies to the second offset potential Vofs2 for mobility correction, the sampling transistor T21 is controlled to an on state again as seen from time t5 of FIG. 35C. Also here, the timing at which the sampling transistor T21 is controlled to an on state is optimized taking the potential of the signal line DTL into consideration.

Further, at the timing at which the sampling transistor T21 is controlled to an on state, also the potential of the current supply line DSL is controlled so as to be changed over to the high potential Vcc. FIG. 39 illustrates an operation state of the pixel circuit at this point of time.

By the application of the second offset potential Vofs2, the gate-source voltage Vgs of the driving transistor T22 becomes wider and the driving transistor T22 enters an on state again.

In particular, supply of current from the current supply line DSL to the pixel circuit is resumed and a first time mobility correction operation is started. The current here reflects the mobility μ of the individual driving transistor T22 and flows so as to charge the storage capacitor Cs and the parasitic capacitance Cel.

Soon, the potential of the signal line DTL changes to the first offset potential Vofs1 as seen from time t6 of FIG. 35C.

Also in the present embodiment, the sampling transistor T21 remains in an on state and also the potential of the current supply line DSL remains in a state of the high potential Vcc. It is to be noted that the on state of the sampling transistor T21 here continues till a point of time at which the writing of the signal potential Vsig is completed. This controlling operation of the sampling transistor T21 is another characteristic of the present embodiment.

Incidentally, upon this potential change, that is, upon the potential change to the first offset potential Vofs1, different distortion appears in response to the distance from the horizontal selector 57. In particular, in a pixel circuit 21 near to the horizontal selector 57, the potential changes to the first offset potential Vofs1 quickly, but in another pixel circuit 21 remote from the horizontal selector 57, the potential changes to the first offset potential Vofs1 in a delayed relationship from that of the pixel circuit 21 near to the horizontal selector 57.

The difference in the changing waveform can be seen from a broken line curve and a solid line curve in FIG. 35C. In particular, a broken line curve in FIG. 35C indicates the potential waveform at a position near to the horizontal selector 57, and a solid line curve in FIG. 35C indicates the potential waveform at a position remote from the horizontal selector 57.

It is to be noted that, also during the change of the potential, the potential of the current supply line DSL maintains the high potential Vcc.

Accordingly, the first time mobility correction operation for the pixel circuit 21 positioned near to the horizontal selector 57 ends early, but the first time mobility correction operation for the pixel circuit 21 positioned remotely from the horizontal selector 57 ends late.

From this difference in correction time, the source potential Vs of the driving transistor T22 which composes a pixel circuit 21 on the remote side from the horizontal selector 57 becomes higher than the source potential Vs of the driving transistor T22 which composes another pixel circuit 21 on the nearer side to the horizontal selector 57 as seen from FIGS. 35D and 35E.

Anyway, the source potential Vs of the driving transistor T22 at a point of time at which the first time mobility correction operation ends is higher than the source potential Vs before the correction operation starts. Accordingly, while the gate potential Vg of the driving transistor T22 changes to the first offset potential Vofs1, the gate-source voltage Vgs of the driving transistor T22 becomes lower than the threshold voltage Vth.

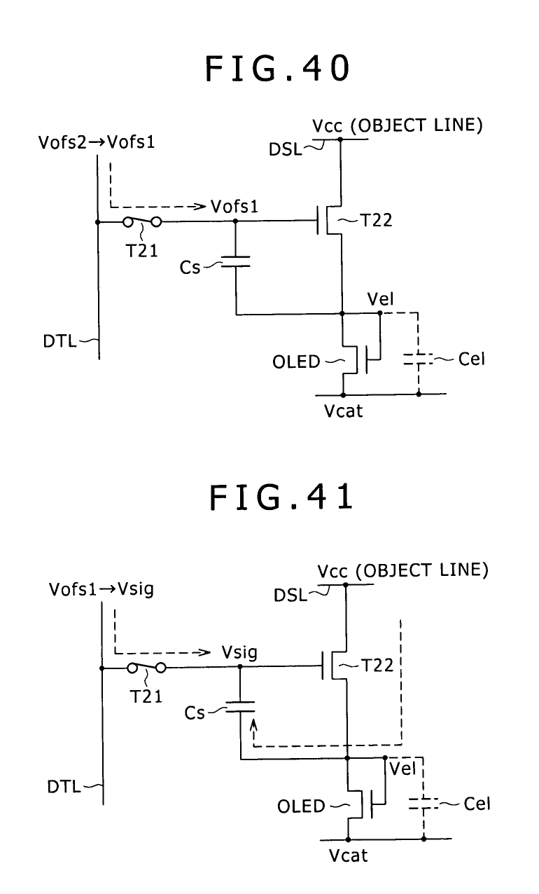

As a result, the driving transistor T22 enters a cutoff state while it maintains the state wherein it keeps the source potential Vs at the point of time at which the first time mobility correction operation ends. FIG. 40 illustrates an operation state of the pixel circuit at this point of time.

Soon, the potential of the signal line DTL changes to the signal potential Vsig as seen from time t7 of FIG. 35C. FIG. 41 illustrates an operation state of the pixel circuit at this point of time. At this point of time, the potential of the current supply line DSL is the high potential Vcc. In an interlocking relationship with the change to the signal potential Vsig, rise of the gate potential Vg of the driving transistor T22 is resumed.

It is to be noted that, also with the potential change here, distortion different in response to the distance from the horizontal selector 57 appears. In particular, at a pixel circuit 21 near to the horizontal selector 57, the potential changes to the signal potential Vsig quickly, but at another pixel circuit 21 remote from the horizontal selector 57, the potential changes to the signal potential Vsig in a delayed relationship from that of the pixel circuit 21 near to the horizontal selector 57.

The difference in the changing waveform can be seen from a broken line curve and a solid line curve in FIG. 35C. In particular, a broken line curve in FIG. 35C indicates the potential waveform at a position near to the horizontal selector 57, and a solid line curve in FIG. 35C indicates the potential waveform at a position remote from the horizontal selector 57.

As a result, the second time mobility correction operation for the pixel circuit 21 positioned nearer to the horizontal selector 57 is started early, but the second time mobility correction operation for the pixel circuit 21 positioned remotely from the horizontal selector 57 is started later.

Besides, the source potential Vs of the driving transistor T22 at the point of time at which the mobility correction operation starts is lower with the pixel circuit 21 nearer to the horizontal selector 57. Therefore, the rising speed of the source potential Vs upon writing of the signal potential Vsig is quicker on the side nearer to the horizontal selector 57.

From the difference in the starting timing of the correction operation and the rising speed of the source potential Vs, the rising amount of the source potential Vs of the driving transistor T22 which composes the pixel circuit 21 nearer to the horizontal selector 57 is greater than that of the source potential Vs of the driving transistor T22 which composes the pixel circuit 21 on the remote side from the horizontal selector 57.

As a result, when a fixed period of time elapses after application of the signal potential Vsig is started, both of the source potential Vs of the driving transistor T22 on the near end side and the source potential Vs of the driving transistor T22 on the remote end side with respect to the horizontal selector 57 converge to a substantially same potential.

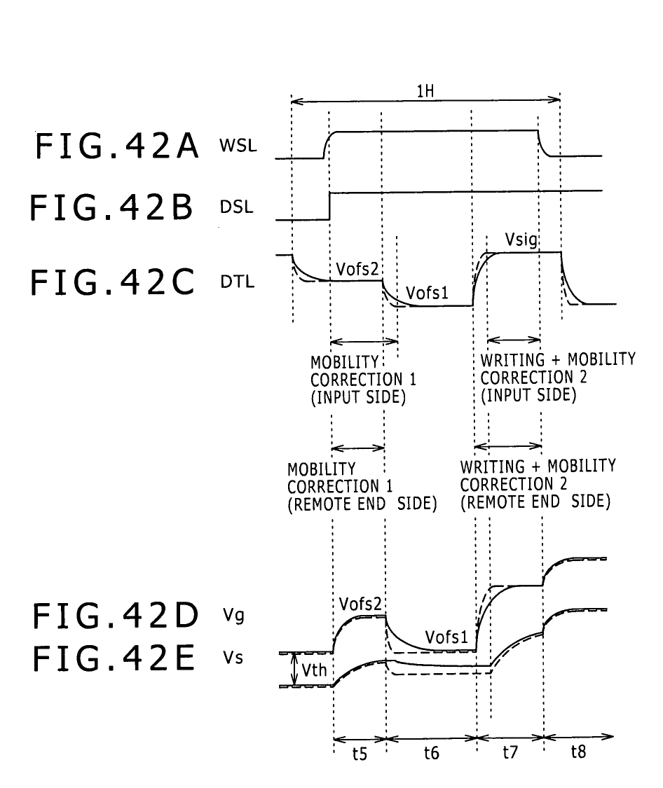

FIGS. 42A to 42E illustrate potential variations of the different portions within the mobility correction period, that is, within the period from time t5 to time t7 in FIGS. 35A to 35E, respectively.

As seen from FIGS. 42A to 42E, the relationship in length between the first time mobility correction time and the second time mobility correction time has a reverse relationship between the near side and the remote side with respect to the horizontal selector 57. Accordingly, the sum of the first and second time mobility correction time periods is equal independently of the distance from the horizontal selector 57. In other words, if the signal potential Vsig is equal, then the gate-source voltage Vgs of the driving transistor T22 assumes an equal value independently of the distance from the horizontal selector 57.

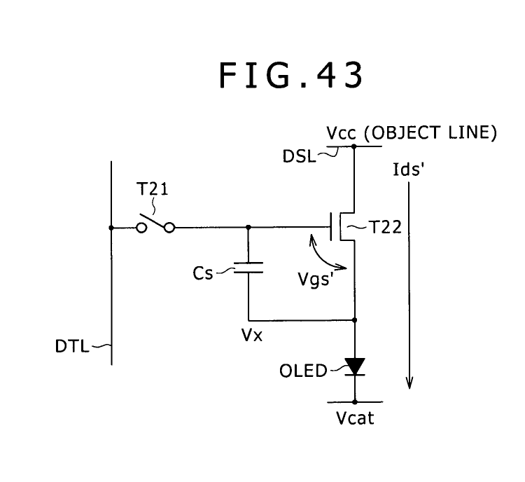

Finally, when the sampling transistor T21 is controlled to an off state to end the writing of the signal potential, supply of the driving current Ids′ of a magnitude corresponding to the gate-source voltage Vgs of the driving transistor T22 to the organic EL element OLED is started. Consequently, emission of light from the organic EL element OLED is started as seen from time t8 of FIG. 35C. FIG. 43 illustrates an operation state of the pixel circuit at this point of time.

Together with this, the anode voltage Vel of the organic EL element OLED rises to the voltage Vx at which driving current Ids′ flows to the organic EL element OLED.

This is the driving operation of the driving circuits provided by the present embodiment. Naturally, also in the present driving method, as the light emission time becomes long, the I-V characteristic of the organic EL element OLED varies similarly as in the embodiment 1.

However, since the amount of current flowing to the organic EL element OLED is always determined by the gate-source voltage Vgs of the driving transistor T22, the luminance of emitted light of the organic EL element OLED is kept at a value corresponding to the signal potential Vsig independently of the variation of the I-V characteristic of the organic EL element OLED.

### C-3. Summary

As described above, the present embodiment adopts a combination of (1) the driving method wherein the signal line DTL is driven in order with the second offset potential Vofs2, first offset potential Vofs1 and signal potential Vsig and a mobility correction operation is executed divisionally twice and (2) the method wherein the on state of the sampling transistor T21 is kept after an intermediate point of an application period of the second offset potential Vofs2 till an intermediate point of a writing period of the signal potential Vsig.

Further, in the present embodiment, the pixel circuit 21 positively utilizes the distortion of the changing waveform of the signal line potential which relies upon the distance from the horizontal selector 57 such that the sum time of the first time mobility correction time and the second time mobility correction time is controlled so as to be substantially fixed independently of the distance from the horizontal selector 57.

Therefore, appearance of shading can be suppressed efficiently, and improvement of the picture quality can be implemented.

Besides, in the case of the present driving technique, since there is no necessity to intentionally distort the waveform within the changing period from the second offset potential Vofs2 to the first offset potential Vofs1, the circuit structure of the horizontal selector 57 can be simplified in comparison with that of the embodiment 1.

Further, although, in order to intentionally distort the waveform of the signal line DTL, at least assurance of the changing period of a fixed time length is essentially demanded, in the case of the driving method of the present embodiment, also the changing period can be included in the mobility correction. Therefore, the present embodiment is advantageous also in reduction of the period within which one cycle of the application of the three different potentials is carried out in comparison with the embodiment 1. As a result, also where one horizontal scanning period becomes shorter as the enhancement of the resolution proceeds, the present embodiment is advantageous in incorporation into a product.

### D. Other Embodiments

### D-1. Other Application Methods of the Writing Potential

In the embodiments described above, one signal line DTL is used commonly for application of three different potentials.

However, three input signal lines may be prepared individually for the three potentials, or two input signal lines including a signal line for one of the three potentials and another signal line for the remaining two potentials may be prepared. In this instance, a sampling transistor is prepared for each of the input signal lines in each pixel circuit, and a mechanism for applying the potentials to the gate electrode of the driving transistor through on/off control of the sampling transistors is applied.

### D-2. Generation Method of the Second Offset Potential Vofs2

In the embodiments described above, the second offset potential Vofs2 is provided with a fixed value. In particular, it is described that the second offset potential Vofs2 is defined as a fixed potential corresponding to an intermediate gradation between the first offset potential Vofs1 and the maximum signal potential Vsig(max).

However, another system wherein the second offset potential Vofs2 is produced individually for individual pixel data Din, that is, for individual values of the signal potential Vsig, may be adopted.

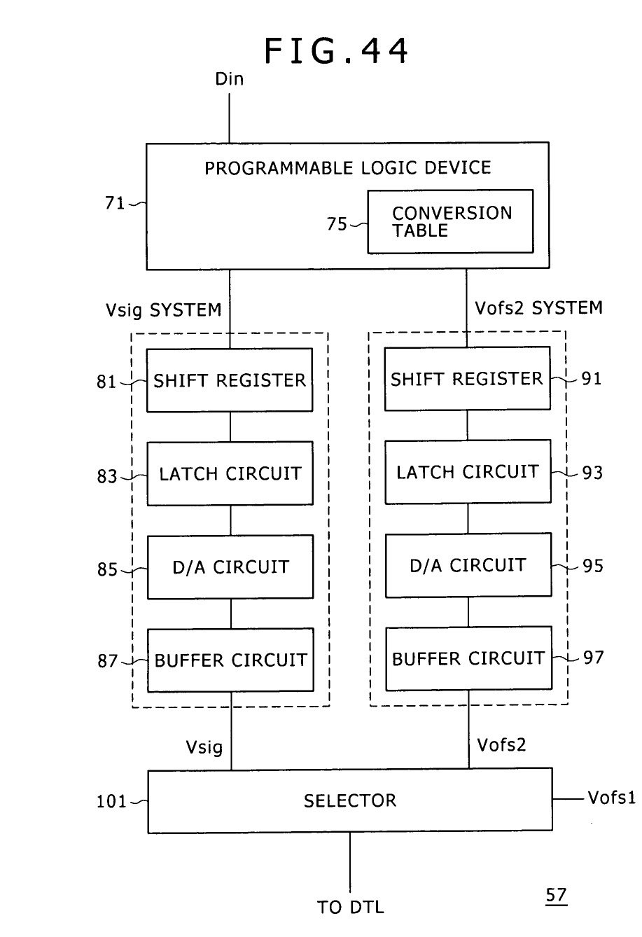

FIG. 44 shows an example of a configuration of the horizontal selector 57 including the system.

Referring to FIG. 44, the horizontal selector 57 includes a programmable logic device 71, a circuit section for the signal potential Vsig, a circuit section for the second offset potential Vofs2, and a selector 101. The circuit section for the signal potential Vsig includes a shift register 81, a latch circuit 83, a D/A circuit 85, and a buffer circuit 87, and the circuit section for the second offset potential Vofs2 includes a shift register 91, a latch circuit 93, a D/A circuit 95 and a buffer circuit 97.

The programmable logic device 71 is a circuit device for successively producing pixel data Din′ which provides the second offset potential Vofs2 based on the magnitude corresponding to the pixel data Din. For the production of the second offset potential Vofs2, a method of executing a mathematical operation process set in advance, a method of referring to a conversion table or a like method may be applied.

For example, where the second offset potential Vofs2 is produced so as to have a value equal to one half of the pixel data Din, a process of shifting the bit values of the pixel data Din by one bit toward the low order side is executed. Naturally, more complicated calculation can be carried out if a processor or a gate circuit is used.

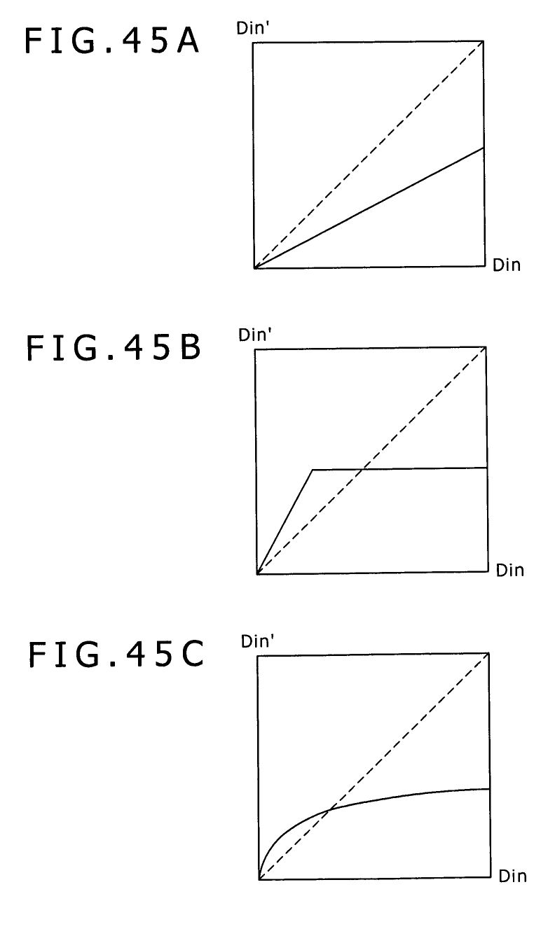

FIG. 44 shows an example of a configuration wherein a conversion table 75 is incorporated in the programmable logic device 71. The conversion table 75 stores all or part of a corresponding relationship between the pixel data Din before the conversion and the pixel data Din′ after the conversion. FIGS. 45A to 45C illustrate examples of an input/output relationship stored in the conversion table 75.

FIG. 45A illustrates an input/output example wherein the corresponding relationship is given by linear conversion. FIG. 45B is a modification to the linear conversion characteristic. In particular, FIG. 45B illustrates an input/output example wherein, to lower side gradations, gradation values higher than those upon inputting are allocated to implement reduction of the mobility correction time, but to higher side gradations, a fixed value lower than the values upon inputting is allocated to implement extension of the mobility correction time.

FIG. 45C illustrates an input/output example where the input/output relationship of FIG. 45B is given with an arbitrary free curved line.

It is to be noted that the shift registers 81 and 91 shown in FIG. 44 are circuit devices for providing an inputting timing of the pixel data Din and Din′, respectively.

The latch circuits 83 and 93 are storage devices for storing the pixel data Din and Din′ for adjusting the output timing, respectively. The D/A conversion circuits 85 and 95 are circuit devices for converting an inputted digital signal into an analog signal.

The buffer circuits 87 and 97 are circuit devices for converting an analog signal into a signal of a signal level suitable for driving of a pixel circuit.

The selector 101 is a circuit device for outputting the second offset potential Vofs2, first offset potential Vofs1 and signal potential Vsig in order to the signal line DTL within one horizontal scanning period.

### D-3. Examples of a Product

a. Electronic Apparatus

In the embodiments described above, the present embodiments are applied to an organic EL panel. However, the organic EL panel is distributed also in the form of a commodity wherein it is incorporated in various electronic apparatus. In the following, various examples wherein the organic EL panel is incorporated in other electronic apparatus are described.

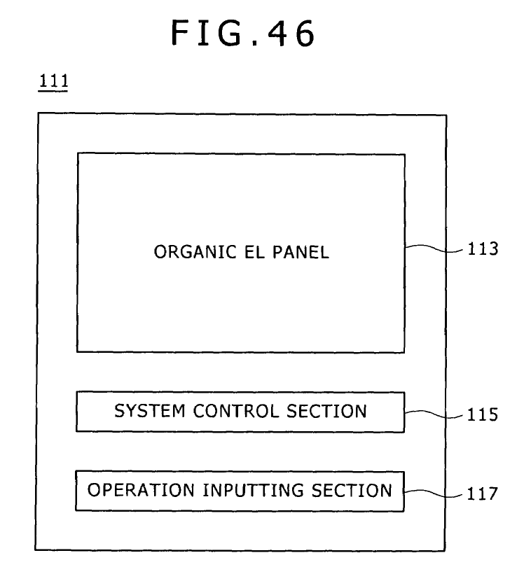

FIG. 46 shows an example of a configuration of an electronic apparatus 111. Referring to FIG. 46, the electronic apparatus 111 includes an organic EL panel 113 described hereinabove, a system control section 115 and an operation inputting section 117. The contents of processing executed by the system control section 115 differ depending upon the form of a commodity of the electronic apparatus 111. The operation inputting section 117 is a device for accepting an operation input to the system control section 115. The operation inputting section 117 may include, for example, switches, buttons or other mechanical interfaces, a graphic interface or the like.

It is to be noted that the electronic apparatus 111 is not limited to an apparatus in a particular field only if it incorporates a function of displaying an image produced in the apparatus or inputted from the outside.

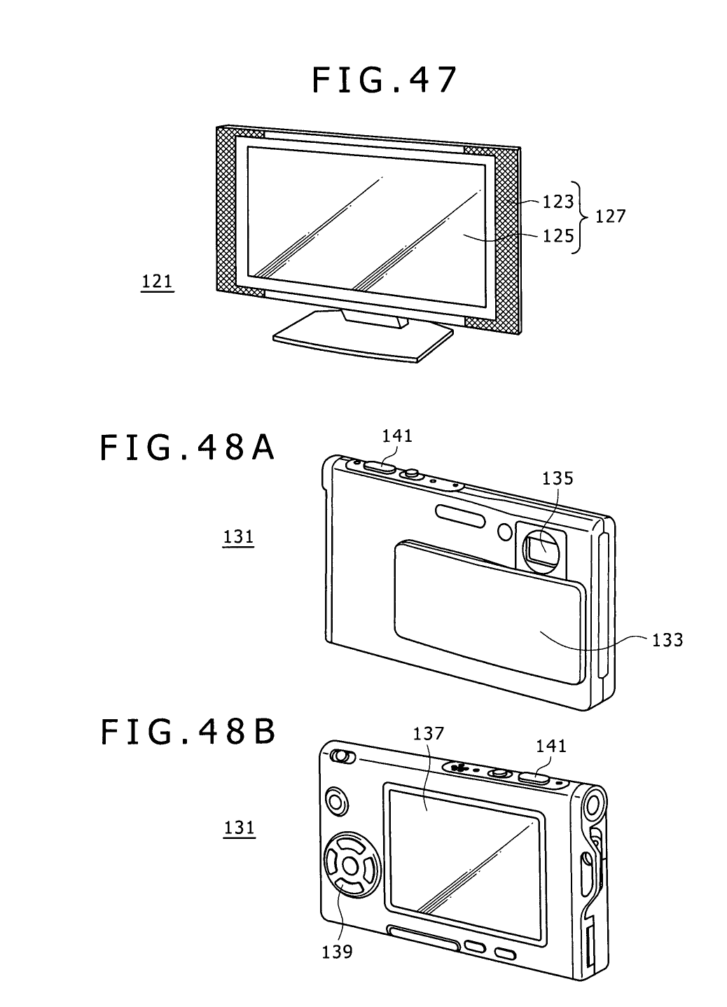

FIG. 47 shows an example of an appearance of an electronic apparatus in the form a television receiver. Referring to FIG. 47, the television receiver 121 includes a display screen 127 provided on the front face of a housing thereof and including a front panel 123, a filter glass plate 125 and so forth. The display screen 127 corresponds to the organic EL panel of any of the embodiments described hereinabove.

The electronic apparatus 111 may alternatively have a form of, for example, a digital camera. FIGS. 48A and 48B show an example of an appearance of a digital camera 131. In particular, FIG. 48A shows an example of an appearance of the front face side, that is, the image pickup object side, and FIG. 48B shows an example of an appearance of the rear face side, that is, the image pickup person side, of the digital camera 131.

Referring to FIGS. 48A and 48B, the digital camera 131 shown includes a protective cover 133, an image pickup lens section 135, a display screen 137, a control switch 139 and a shutter button 141. The display screen 137 corresponds to the organic EL panel of any of the embodiments described hereinabove.

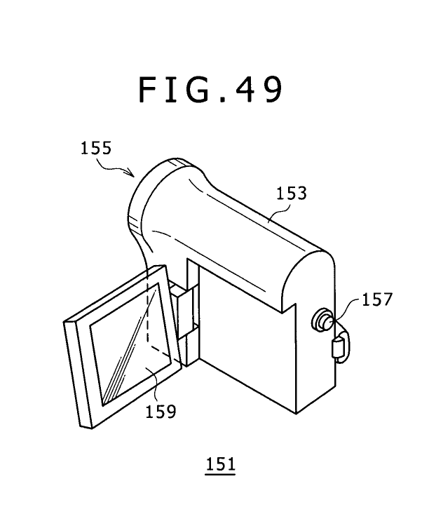

The electronic apparatus 111 may otherwise have a form of, for example, a video camera. FIG. 49 shows an example of an appearance of a video camera 151.

Referring to FIG. 49, the video camera 151 shown includes a body 153, and an image pickup lens 155 for picking up an image of an image pickup object, a start/stop switch 157 for image pickup and a display screen 159, provided at a front portion of the body 153. The display screen 159 corresponds to the organic EL panel of any of the embodiments described hereinabove.

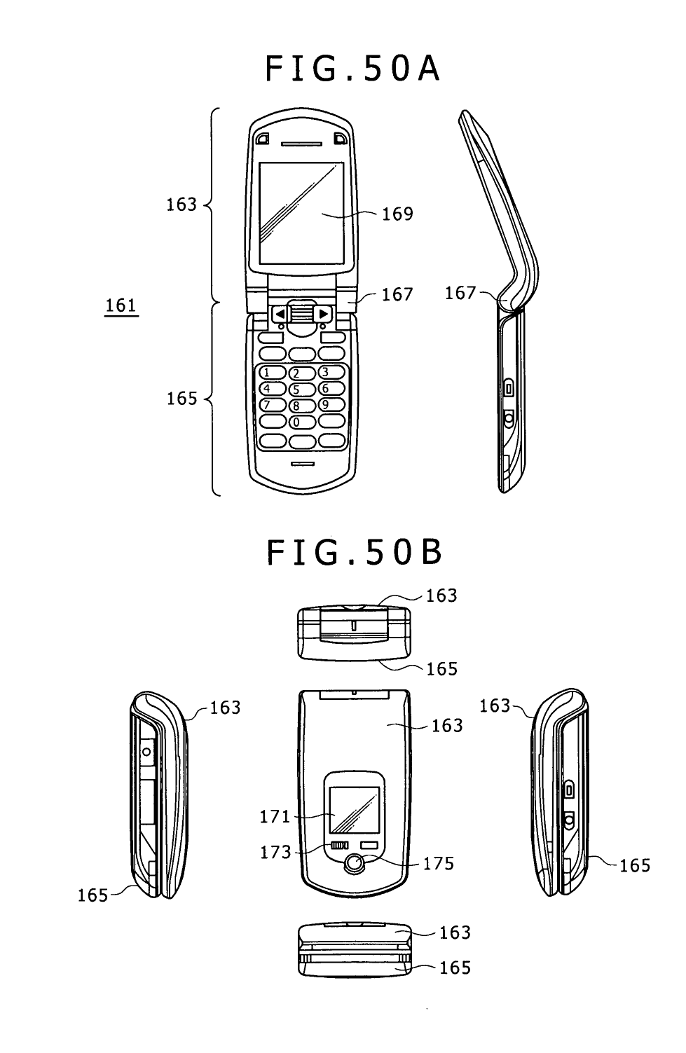

The electronic apparatus 111 may alternatively have a form of, for example, a portable terminal apparatus. FIGS. 50A and 50B show an example of an appearance of a portable telephone set 161 as a portable terminal apparatus. Referring to FIGS. 50A and 50B, the portable telephone set 161 shown is of the foldable type, and FIG. 50A shows an example of an appearance of the portable telephone set 161 in a state wherein a housing thereof is unfolded while FIG. 50B shows an example of an appearance of the portable telephone set 161 in another state wherein the housing thereof is folded.

The portable telephone set 161 includes an upper side housing 163, a lower side housing 165, a connection section 167 in the form of a hinge section, a display screen 169, a sub display screen 171, a picture light 173 and an image pickup lens 175. The display screen 169 and the sub display screen 171 correspond to the organic EL panel of any of the embodiments described hereinabove.

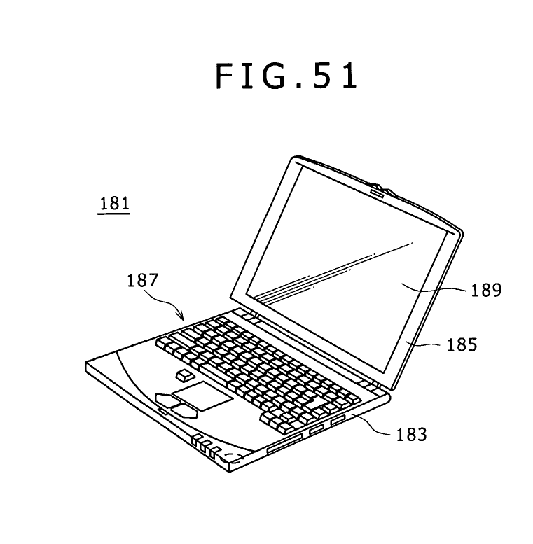

The electronic apparatus 111 may otherwise have a form of, for example, a computer. FIG. 51 shows an example of an appearance of a notebook type computer 181.

Referring to FIG. 51, the notebook type computer 181 shown includes a lower side housing 183, an upper side housing 185, a keyboard 187 and a display screen 189. The display screen 189 corresponds to the organic EL panel of any of the embodiments described hereinabove.

The electronic apparatus 111 may otherwise have various other forms such as an audio reproduction apparatus, a game machine, an electronic boot and an electronic dictionary.

### D-4. Other Examples of a Display Device

In the foregoing description of the embodiments, the present embodiments are applied to an organic EL panel.

However, the driving technique described above can be applied also to EL display apparatus of other types. For example, the present embodiment can be applied also, for example, to a display apparatus wherein a plurality of LEDs are arrayed and another display apparatus wherein a plurality of light emitting elements having some other diode structure are arrayed on a screen. For example, the driving technique can be applied also to an inorganic EL panel.

### D-5. Others

The embodiments described above may be modified in various manners without departing from the spirit and scope of the present invention. Also various modifications and applications may be created or combined based on the disclosure of the present invention.

What is claimed is:

1. An EL display panel having a pixel structure ready for an active matrix driving method, comprising:
an input signal line driving section configured to output an intermediate potential for mobility correction, a threshold value correction potential and a signal potential corresponding to a gradation value in order for each horizontal scanning period; and
a writing controlling driving section configured to have a control period for keeping an on state of a sampling transistor for controlling writing of the potentials within a period beginning with a timing midway of an application period of the intermediate potential and ending with another point of time midway of an application period of the signal potential.

2. The EL display panel according to claim 1, wherein the intermediate potential is higher than the threshold value correction potential but lower than a maximum potential of a variation range of the signal potential.

3. The EL display panel according to claim 1, wherein the intermediate potential is successively produced based on the signal potential.

4. The EL display panel according to claim 3, wherein the intermediate potential is produced through a mathematical operation process.

5. The EL display panel according to claim 3, wherein the intermediate potential is produced through hardware processing.

6. The EL display panel according to claim 3, wherein the intermediate potential is produced through a conversion process using a reference table.

7. The EL display panel according to claim 1, wherein the intermediate potential is a fixed potential set in advance.

8. The EL display panel according to claim 3, wherein the intermediate potential, threshold value correction potential and signal potential are applied through a common input signal line.

9. The EL display panel according to claim 7, wherein the intermediate potential, threshold value correction potential and signal potential are applied through a common input signal line.

10. An electronic apparatus, comprising:
an EL display panel having a pixel structure ready for an active matrix driving method, an input signal line driving section configured to output an intermediate potential for mobility correction, a threshold value correction potential and a signal potential corresponding to a gradation value in order for each horizontal scanning period, and a writing controlling driving section configured to have a control period for keeping an on state of a sampling transistor for controlling writing of the potentials within a period beginning with a timing midway of an application period of the intermediate potential and ending with another point of time midway of an application period of the signal potential;
a system control section configured to control operation of said EL display panel; and
an operation inputting section configured to accept an operation input to said system control section.

11. A driving method for an EL display panel having a pixel structure ready for an active matrix driving method, comprising the steps of:
outputting an intermediate potential for mobility correction, a threshold value correction potential and a signal potential corresponding to a gradation value in order for each horizontal scanning period; and
keeping an on state of a sampling transistor for controlling writing of the potentials within a period beginning with a timing midway of an application period of the intermediate potential and ending with another point of time midway of an application period of the signal potential.

12. An EL display panel having a pixel structure ready for an active matrix driving method, comprising:
input signal line driving means for outputting an intermediate potential for mobility correction, a threshold value correction potential and a signal potential corresponding to a gradation value in order for each horizontal scanning period; and
writing controlling driving means for having a control period for keeping an on state of a sampling transistor for controlling writing of the potentials within a period beginning with a timing midway of an application period of the intermediate potential and ending with another point of time midway of an application period of the signal potential.
